(19) United States
(12) Patent Application Publication
(10) Pub. No.: US 2020/0183079 A1
(43) Pub. Date: Jun. 11, 2020

(54) DISPLAY DEVICE COMPRISING A LIGHT GUIDE

(71) Applicant: SEEREAL TECHNOLOGIES S.A., Munsbach (LU)

(72) Inventor: Norbert LEISTER, Dresden Sachsen (DE)

(21) Appl. No.: 16/614,407

(22) PCT Filed: May 18, 2018
(86) PCT No.: PCT/EP2018/063093

§ 371 Date: Nov. 18, 2019

(30) Foreign Application Priority Data
May 19, 2017 (EP) 17171979.2

(51) Int. Cl. F21V 8/00; G02F 1/29; G02B 27/01; G03H 1/22

(52) U.S. Cl. CPC G02B 6/0055; G02B 6/0053; G02B 6/0016; G02F 1/29; G02B 27/0172; G03H 2225/11; G03H 1/2294; G02F 2001/294; G02B 2027/0174; G02B 2027/0123; G02B 2027/0134; G03H 1/2205

(57) ABSTRACT

The invention relates to a display device, in particular a provided near-to-eye display device of a user. The display device comprises at least one illumination device, at least one spatial light modulator device, at least one imaging element, at least one light guide, and at least two partially-reflective decoupling elements. The at least one illumination device is used for emitting sufficiently coherent light. The at least one imaging element is provided for imaging light originating from the at least one light modulator device. The at least two partially-reflective decoupling elements, which are provided in the at least one light guide, are used for coupling the light out of the light guide.

The invention relates to a display device for representing preferably three-dimensional objects or scenes. In particular, the invention relates to a near-to-eye display device, for example, a head-mounted display, where head-up displays are also to be included.

For a head-mounted display (HMD) or a similar near-to-eye display of a user or display device, it is desirable and advantageous to provide and to ensure a compact and light optical setup, since these types of displays are worn on the head of a user and a pleasant wearing feeling is to be given to the user.

In the case of an AR (Augmented Reality)—head-mounted display it is moreover desirable for a user to be capable of perceiving his natural surroundings as much as possible without disturbances due to the head-mounted display, on the one hand, and to be able to perceive well the content displayed on the head-mounted display itself without problems, on the other hand.

If a spatial light modulator device and an optical arrangement for imaging of the spatial light modulator device are used, in this case the optical arrangement is to be conceived, however, so that both light from the spatial light modulator device and also light from natural surroundings of the user or observer can be guided to or can reach the eye or eyes.

The field of view (FoV) is also of great importance for the user comfort in a head-mounted display. The largest possible field of view is therefore advantageous.

AR displays or AR display devices are also known, which use a light guide or a waveguide to direct or guide light from a spatial light modulator device to an eye. A user then additionally sees his natural surroundings through the light guide or waveguide.

Such a light guide, which comprises partially-reflective mirrors for decoupling the light to achieve a relatively large field of view at low thickness of the light guide, is described in U.S. Pat. No. 6,829,095 B2. Light, which is coupled at a specific angle into this light guide and propagates in the light guide in the zigzag mode or via total reflection, is incident on partially-reflective mirrors in a decoupling region. By means of a partially-reflective mirror, the light is coupled out of the light guide again at the same angle at which it is coupled into the light guide. In this case, the light of a scene image located in infinity is coupled into the light guide. If such a light guide, as disclosed in U.S. Pat. No. 6,829,095 B2, is used in conjunction with a spatial light modulator (SLM) for example, a LCOS (liquid crystal on silicon) SLM or a self-emitting OLED (organic light emitting device) SLM, which is imaged into infinity, light thus propagates from a single pixel of the spatial light modulator essentially parallel to one another. Light from different pixels of the spatial light modulator differs by way of its propagation angle depending on the location of the pixel on the spatial light modulator, however. Accordingly, if light which originates from one pixel of the spatial light modulator and has a fixed propagation angle is coupled into the light guide and is coupled out of the light guide again at another position at the same angle, the light is thus also incident at the same angle on the eye of an observer of the light guide.

In such a case, if the spatial light modulator is imaged into infinity and, without the presence of a light guide, an observer would see an image of the spatial light modulator in infinity, the propagation of the light through the light guide would advantageously leave the depth position of the image of the spatial light modulator unchanged. The decoupling position and also the optical path which the light covers through the light guide have no influence on the depth position of the image of the spatial light modulator in this case. An observer therefore still perceives an image of the spatial light modulator in infinity. The location of a pixel on the image of the spatial light modulator results by way of the decoupling angle of the light from this pixel out of the light guide. The eye of the observer then sees the image of the spatial light modulator through the light guide in the same manner as if the eye were looking directly at the image of the spatial light modulator, in the case in which no light guide was present.

Such an arrangement would only function, however, for an image of the spatial light modulator in infinity. This may be explained as follows: light from the same pixel of the spatial light modulator which is coupled into the light guide and is coupled out by different partially-reflective mirrors covers optical paths of different lengths in the light guide. However, this is not important as long as the image of the pixel is an infinite distance away from the eye of the observer, because the paths of the light from the image of the pixel through the light guide to the eye are then all infinitely long. However, the different paths of the light from the pixel to the eye of the observer would play an important role if the image of the spatial light modulator at finite distance from the eye were generated by an image in the light path before the coupling into the light guide. The different paths of the light from the same pixel of the spatial light modulator, which is coupled into the light guide and coupled out by different partially-reflective mirrors, would then have the effect that the depth position of the image visible to an observer is influenced by different partially-reflective mirrors in different ways. An observer would then see an image of the pixel at a different distance through a first partially-reflective mirror than through an adjacent second partially-reflective mirror.

At any rate, it is necessary if such a light guide according to U.S. Pat. No. 6,829,095 B2 is used in a display device that an image of the spatial light modulator in infinity is generated in the light path before the coupling into the light guide. Parallel light thus propagates through the light guide from every pixel of the spatial light modulator. It is then possible to arrange a lens which changes the image position of the spatial light modulator in the light path after the coupling of the light out of the light guide, i.e., between the light guide and the eye of an observer. Since the lens which changes the image position is only arranged in the light path after the coupling of the light out of the light guide, the optical path of the light in the light guide has no influence on the depth position of the image of the spatial light modulator in this case. However, the light from the natural surroundings of the observer, which passes through the light guide, is also deflected by this lens, so that then objects from the natural surroundings of the observer appear at an incorrect distance from the observer. Therefore, arrangements are known which provide a compensation lens on the other side of the light guide facing away from the eye. The light from the natural surroundings then passes through both lenses, where the compensation lens cancels out the focus effect of the lens between the light guide and the eye. The light originating from the spatial light modulator only passes through one of the two lenses, so that the image of the spatial light modulator can be displaced in the depth by this lens. The light from the natural surroundings of the observer passes through both lenses, however, so that the natural surroundings appear at a normal fixed distance unchanged by the display device.

By way of such an embodiment of a light guide arrangement, an image of the spatial light modulator at a finite fixed depth results for an observer. As already mentioned, however, the light path from the spatial light modulator up to the coupling of the light out of the light guide has to correspond to that of an image of the spatial light modulator in infinity.

Such a light guide thus generates an image of a spatial light modulator at a fixed depth. It is possible in this case to generate either monoscopic images for one eye of an observer or, for example, also to generate stereoscopic images at a fixed depth using a combination of separate light guides for the left and the right eye of an observer.

A single light guide is only capable in this case of generating a large field of view in one direction. To expand the field of view both horizontally and also vertically, a combination of two light guides can be used, which are arranged perpendicularly in relation to one another and of which, for example, a first light guide defines and generates the vertical field of view and a second light guide defines and generates the horizontal field of view.

Thin light guides, which use a single prism or a single mirror to couple in light but multiple partially-reflective mirrors to couple light out, comprise a relatively small coupling area in comparison to the decoupling area thereof.

To be able to couple light from a large field of view into a light guide on a limited area, it is necessary for the light from all pixels of the spatial light modulator to be concentrated on or close to the coupling area of the light guide on a small region. In other words, a projection optical unit for imaging of the spatial light modulator is to have its exit pupil at or close to the coupling area of the light guide so that the light can be coupled in.

Furthermore, holographic head-mounted displays (HMD) having a virtual observer region or observer window are known, from which and out of which a preferably three-dimensional (3D) scene is visible and observable. Holographic representations have the advantage that actual depth is generated and therefore a vergence-accommodation conflict is avoided. The vergence-accommodation conflict occurs in particular in the case of stereoscopic display devices or displays, for example, as disclosed in U.S. Pat. No. 6,829,095 B2, if an observer focuses on the display area or on the surface of the spatial light modulator so that he perceives it sharply. The disparation of the two displayed stereoscopic images suggests three-dimensional objects which are visible in front of or behind the display area. In this case, the eyes converge on the apparent distance of these objects from the display area. The object thus becomes fixed and is to be perceived sharply. However, the object is not actually located at a distance from the display area, so that the observer no longer sharply sees the object when he fixes it. Headaches or other types of discomfort can thus occur very frequently in observers when observing stereoscopic scenes or objects.

However, these negative influences can be avoided upon the use of holographic display devices or displays.

A head-mounted display having a virtual observer region is described in U.S. Pat. No. 8,547,615 B2, in which the observer region is generated alternately either as a Fourier transform of the spatial light modulator or as an image of the spatial light modulator.

A holographic head-mounted display having a virtual observer region is disclosed in U.S. Pat. No. 9,406,166 B2, which achieves a large field of view by means of tiling or segmenting. In this case, different parts of the field of view, which are visible from a virtual observer region, are generated time-sequentially using a spatial light modulator and a suitable optical system. In this document, the tiling/segmenting is also described as “a multiple image of the spatial light modulator composed of segments”, because the spatial light modulator is imaged in each case for each segment.

In one embodiment of U.S. Pat. No. 9,406,166 B2, the use of a waveguide is also disclosed, in which light is coupled and coupled out by means of gratings, in particular volume gratings. Inter alia, the use of gratings having large deflection angles in a holographic reconstruction can generate aberrations in the image position of the spatial light modulator and the object points of the three-dimensional scene, which have to be complexly corrected.

In contrast, the use of a light guide in which the light path is only deflected via prisms and/or reflected on mirrors or at most comprises gratings having small deflection angles, for example, angles <15°, is advantageous because smaller aberrations result in this case in comparison to a deflection using gratings.

In such a holographic display device according to U.S. Pat. No. 8,547,615 B2 or also U.S. Pat. No. 9,406,166 B2, a three-dimensional scene is generated using object points which are located in different depth planes. At least approximately coherent light is used in this case. Object points, which are located in front of or behind the spatial light modulator, are generated by subholograms written or encoded in the spatial light modulator. With sufficiently coherent illumination of the spatial light modulator, the object points already result as focus points in the space in the surroundings of the spatial light modulator, i.e., in the light path before a possible coupling of the light into a light guide, if the light guide is arranged between the spatial light modulator and an eye of an observer of a scene to be reconstructed.

Even though the spatial light modulator itself would be imaged at an infinite distance in the case of a holographic display device, the object points of the three-dimensional scene to be reconstructed would thus be located at a finite distance from the eye of the observer. If a light guide is used in a display device which generates and displays three-dimensional scenes on a holographic basis, it is thus necessary for not only light from a single plane, i.e., the plane of the spatial light modulator, to propagate through the light guide, but rather also light from a three-dimensional volume of object points, and for these object points to be visible without significant disturbances for an observer who looks through the light guide.

A light guide which would only function for the propagation of light of an image of the spatial light modulator in infinity, for example, the light guide arrangement according to U.S. Pat. No. 6,829,095 B2, therefore does not appear suitable in this way for the use in a holographic display device.

Moreover, the disadvantage results that the use of at least approximately coherent light, as is required for a holographic reconstruction, in a light guide which is based on partially-reflective mirrors, for example, as disclosed in U.S. Pat. No. 6,829,095 B2, results in disturbing interference of light which originates, for example, from the same pixel of the spatial light modulator but is partially coupled out after paths of different lengths in the light guide by different partially-reflective mirrors and then propagates further after the decoupling and interferes in this case.

It is therefore an object of the present invention to provide a display device, in particular a near-to-eye display device, which enables a large visibility region or field of view to be generated. A further object of the present invention is to provide a display device which has a compact and light setup.

Furthermore, it is an object of the invention to refine a device according to U.S. Pat. No. 6,829,095 B2 in such a way that such a light guide can be used for coupling and/or coupling out of light from the light guide for holographic generation of preferably three-dimensional scenes.

The present object is achieved according to the invention by the features of claim 1.

According to the invention, a display device is proposed, which is particularly suitable for use in near-to-eye displays and in particular in head-mounted displays here, but the use is not to be restricted to these displays, but rather it can also be used, for example, in head-up displays. Such a display device according to the invention comprises at least one illumination device for emitting sufficient coherent light, at least one spatial light modulator device, at least one imaging element for imaging light originating from the at least one light modulator device, at least one light guide, and at least two partially-reflective decoupling elements, which are provided in the at least one light guide, for coupling the light out of the light guide.

In this way, a display device can be provided which has a compact setup, is thus embodied as lightweight, and can generate an enlarged field of view or field of vision at least in one direction, for example, in the horizontal direction. Moreover, the light guide arrangement of U.S. Pat. No. 6,829,095 B2 has been refined in such a way that it can now also be used in a holographic display device to reconstruct and represent a three-dimensional scene holographically.

For this purpose, the partially-reflective decoupling elements can advantageously be designed as mirror elements or prism elements.

Occurring aberrations can be kept small and/or substantially reduced by the use of mirror elements as decoupling elements. Moreover, a compact optical system can thus be enabled. For example, the at least one light guide can comprise between 4 and 10 partially-reflective decoupling elements, which are designed as mirror elements. However, the invention is not to be restricted to this number. In other embodiments, the at least one light guide can also comprise fewer or more partially-reflective decoupling elements.

The partially-reflective decoupling elements in the at least one light guide can be produced, for example, as a type of dielectric layer stack which is applied to a substrate.

Further advantageous embodiments and refinements of the invention may be found in the further dependent claims.

In one advantageous embodiment of the invention, it can be provided that the partially-reflective decoupling elements are parallel to one another. In this manner, light beams from the same pixel of the at least one spatial light modulator device, which are incident at a specific angle on various partially-reflective decoupling elements, can also be coupled out of the light guide at the same angle.

Moreover, it can be advantageous if the partially-reflective decoupling elements are arranged at a predefined and preferably equal distance in each case in relation to one another. If the distance of the decoupling elements becomes excessively large, for example, undesired gaps would result in a generated sweet spot.

If the partially-reflective decoupling elements are mirror elements, the distance thereof to one another is to be selected in one preferred embodiment in such a way that the projection of the partially-reflective decoupling elements on the surface of the at least one light guide results in a coherent surface without gaps and without overlap of the projected decoupling elements.

The partially-reflective decoupling elements can be arranged in this case in such a way that these decoupling elements deflect the light propagating in the at least one light guide in a predefined direction, for example, in the direction of an eye of an observer.

In one advantageous embodiment of the invention, it can furthermore be provided that a light coupling device is provided, using which the light incident on the at least one light guide can be coupled into the light guide.

The light coupling device preferably comprises at least one mirror element and/or one grating element and/or one prism element.

The display device according to the invention can advantageously comprise a holographic single parallax encoding. In other words, a one-dimensional hologram can be encoded in the at least one spatial light modulator device. The encoding direction of the one-dimensional hologram in the spatial light modulator device can preferably be the vertical direction, where the encoding direction is provided perpendicularly in relation to a non-encoding direction of the one-dimensional hologram. The non-encoding direction is in the horizontal direction in this regard. Of course, the invention is not to be restricted to this embodiment of the encoding direction and non-encoding direction, but rather also the reverse case can be provided, in which the encoding direction is the horizontal direction and the non-encoding direction is the vertical direction. Other directions of the encoding direction and non-encoding direction perpendicular in relation to one another, for example, inclined directions, are also conceivable and possible.

In particular, in one advantageous embodiment of the invention, the encoding direction is perpendicular in relation to the direction in which the partially-reflective decoupling elements are arranged in succession in the at least one light guide. In a light guide in which multiple partially-reflective decoupling elements are arranged horizontally adjacent to one another, a vertical encoding direction of a hologram is preferably used. In a light guide in which multiple partially-reflective decoupling elements are arranged vertically one over another, a horizontal encoding direction of a hologram is preferably used.

However, the invention is not to be restricted to a single parallax encoding. Rather, it is also possible to also apply the present invention to a full parallax encoding of a hologram in the at least one spatial light modulator device.

It is preferably assumed for the invention that a light guide having partially-reflective decoupling elements represents a one-dimensional arrangement, which, in combination with a spatial light modulator device, essentially also only requires light which is parallel and/or collimated in one direction and originates from the pixels of the spatial light modulator device.

For a holographic single parallax encoding, on the other hand, an astigmatism is present in the position of a three-dimensional object point of a scene to be represented. The scene is divided into object points, where each object point is encoded as a subhologram of an overall hologram in the spatial light modulator device. In the case of a single parallax encoding, an overall hologram is encoded in each case on the entire area of the spatial light modulator device, where the overall hologram is generated by adding up the subholograms of the object points. To generate three-dimensional object points, according to the invention, in the case of the preferred single parallax encoding, object points are therefore generated in front of the spatial light modulator device or a virtual image of an object point is generated behind the spatial light modulator device, viewed from the direction of an observer of the object points of a scene, only in the encoding direction by means of encoded subholograms. In the non-encoding direction of the subholograms or the hologram perpendicular thereto, the focus of the subhologram of the object point is located in the plane of the image of the spatial light modulator device. This fact can thus be advantageously utilized for the display device according to the invention, which comprises at least one light guide.

The display device according to the invention comprises an imaging beam path and an illumination beam path. An image of the spatial light modulator device visible to an observer is generated by means of the imaging beam path. The illumination beam path, in contrast, has an influence on the occurrence of a virtual observer region or a sweet spot. A virtual observer region is generated, for example, in the plane of an image of at least one light source of the at least one illumination device.

Provided imaging elements in the light path between the at least one spatial light modulator device and an observer of a three-dimensional scene to be reconstructed can generally influence both beam paths, illumination beam path and imaging beam path. In specific positions or at specific locations in the light path, they can also only or primarily influence one of the two beam paths. For example, a lens element which is arranged directly at the at least one spatial light modulator device does not change the imaging beam path but rather only the illumination beam path.

The display device according to the invention comprises at least one imaging element, which influences at least the imaging beam path.

In advantageous embodiments of the invention, the display device according to the invention can comprise at least one further imaging element, which influences at least the illumination beam path.

The at least one imaging element can be or comprise at least one lens element, and/or one mirror element and/or one grating element. It is also possible to use and to combine multiple imaging elements to form an imaging system.

The at least one imaging element can advantageously be arranged in the light direction before the at least one light guide, in particular between the at least one spatial light modulator device and the at least one light guide.

In this case, the at least one imaging element, which influences at least the imaging beam path, can be provided for imaging of the at least one spatial light modulator device into infinity.

An image of the spatial light modulator device in infinity can be generated with the aid of the at least one imaging element. Viewed with respect to a preferred single parallax encoding, a light propagation can thus essentially take place with parallel and/or collimated light perpendicular to the encoding direction of a hologram through the light guide or in the light guide, for example, from the pixels of a pixel column or pixel row of the spatial light modulator device. However, the light is focused by the individual subholograms on the respective object points in the encoding direction of the hologram. Light beams which are divergent or convergent at a small angle, for example, then originate from the object points.

The divergent or convergent light beams can pass or penetrate the light guide in the encoding direction, so that the object points are visible at a finite distance for an observer of the scene.

The holographic display device according to the invention could thus comprise object points at a finite distance and an image of the spatial light modulator device in infinity.

However, a single parallax hologram encoding generally supplies a better visible resolution for a three-dimensional scene, the object points of which are located closer to the spatial light modulator device or an image plane of the spatial light modulator device, and a somewhat less well visible resolution for a three-dimensional scene, the object points of which are located farther away from the spatial light modulator device. If, for example, the image of the spatial light modulator device is at 2 m distance from an observer, a depth range of approximately 1.3 m to 6 m distance from the observer can thus be represented with good resolution. In general, the region behind the image plane of the spatial light modulator device, for which a good resolution is achievable, is greater in this case than the range in front of the image plane of the spatial light modulator device.

If the image of the spatial light modulator device is in infinity, only the region in front of the image of the spatial light modulator device can be used for the representation of object points. Object points for which a good resolution is achievable using a single parallax hologram encoding then have a relatively large distance to the observer. The region which may be represented in good resolution is located at multiple meters from the observer for an image of the spatial light modulator device in infinity.

It can therefore be more advantageous if the image of the spatial light modulator device is located at a finite distance from the observer, because then a depth range both in front of and also behind the spatial light modulator device can be used for the representation of object points close to or in the vicinity of the spatial light modulator device. A reasonable distance of the image of the spatial light modulator device would be, for example, the above-mentioned 2 m distance from the observer or also lesser distances or somewhat greater distances, for example, in preferred embodiments a range for the image of the spatial light modulator device between 0.7 m and 2 m or in further embodiments also a larger range between 0.5 m and 5 m. However, the invention is not to be restricted to these distances of the image of the spatial light modulator device.

It can therefore be provided in one advantageous embodiment of the invention that at least one further imaging element is provided, which again influences at least the imaging beam path and is arranged in the light direction after the at least one light guide. The at least one further imaging element is advantageously provided for imaging of an intermediate image of the at least one spatial light modulator device, which is generatable in infinity by the at least one imaging element, at a finite distance. In other words, this at least one further imaging element images the intermediate image of the spatial light modulator device, which was generated by the at least one imaging element in the light path in infinity before the coupling into the at least one light guide, in an image of the spatial light modulator device at a finite distance. In this manner, an image of the spatial light modulator device can be generated visible to the eye of an observer at finite distance. A distance at a distance between 0.7 m and 2 m or in a further embodiment of 0.5 m to 5 m from the observer is preferably used. By way of this further imaging element, which can advantageously be arranged in the light direction after the at least one light guide, i.e., between the light guide and an eye of an observer, not only the image of the spatial light modulator device can be displaced, but rather also the location of the object points in space can be displaced.

If the further imaging element, which influences at least the imaging beam path, is, for example, a lens element having a negative focal length of −2 m, the intermediate image of the spatial light modulator device in infinity is thus furthermore imaged on an image visible to the observer at 2 m distance.

The object points are in this case then encoded in one preferred embodiment as subholograms on the spatial light modulator device in such a way as if a physical or real spatial light modulator device were located at a finite distance after the light guide and the eye of an observer saw or looked directly at the spatial light modulator device.

In one embodiment, the at least one further imaging element, which influences at least the imaging beam path and is arranged in the light path after the coupling of the light out of the at least one light guide, is configured static, for example, as a lens element having fixed focal length, where the image of the at least one spatial light modulator device visible to the observer is generated at a fixed distance from the observer.

In another embodiment, the at least one further imaging element, which influences at least the imaging beam path and is arranged in the light path after the coupling of the light out of the at least one light guide, is designed as controllable or switchable, for example, as a lens element having variable focal length or also a controllable grating element. Methods are also known, using which an imaging element can obtain a variable focal length by mechanical shift or rotation of refractive or diffractive optical elements (Alvarez lenses or Moiré lenses). The at least one further imaging element could also be embodied as such an Alvarez lens or Moiré lens. It can thus be provided that the at least one further imaging element comprises at least one lens element and/or at least one imaging element having a variable focal length and/or at least one switchable imaging element.

It is also possible, for example, to switch between two focal lengths of this lens system by way of a combination of two lens elements in the light path after the coupling of the light out of the at least one light guide, a fixed lens element and a switchable or controllable lens element. An image of the spatial light modulator device can thus be generated time-sequentially in two different depth planes. The object points of the three-dimensional scene can be divided into object points which are located closer to the one or the other image plane of the spatial light modulator device, to compute and display a hologram in each case in a shorter computation time. With the aid of this division and/or assignment of object points to different depth planes of an image of the spatial light modulator device, an overall greater depth range having object points close to or in the vicinity of the spatial light modulator device can be generated. Of course, the invention is not to be restricted to the use of images of the spatial light modulator device in two different depth planes. It is also possible to use images of the spatial light modulator device in more than two depth planes, to compute and represent a hologram in each case. It is also possible, for example, to carry out gaze tracking and to carry out a displacement of the image plane of the at least one spatial light modulator device in accordance with the depth in which an observer presently focuses. The preferred single parallax encoding of a hologram permits in each case a three-dimensional scene to be represented with greater depth. However, the highest spatial resolution is generated in the depth in which the observer focuses with his eyes.

In a further advantageous embodiment of the invention, at least one compensation element can be provided. The compensation element can in this case preferably be arranged on the side of the at least one light guide opposite to the at least one further imaging element.

A compensation element, for example, a compensation lens, can thus be provided between the at least one light guide and the natural surroundings, which has the effect that the perception of the natural surroundings by the observer is not impaired by the at least one further imaging element between the light guide and the eye of the observer.

If, for example, the at least one further imaging element is designed as a lens element having a negative focal length of −2 m, the compensation element is thus to be a lens element having a positive focal length of +2 m.

The mentioned division and/or assignment of object points to various depth planes of an image of the spatial light modulator device with the aid of a variable or switchable further imaging element can be combined with a compensation element which comprises at least one lens element, at least one imaging element having variable focal length, and/or at least one switchable and/or controllable imaging element. The compensation element, arranged between the light guide and the natural surroundings of an observer, can also comprise a switchable element, so that the distance of the natural surroundings to the observer is corrected in each case for both or also multiple image positions of the image of the spatial light modulator device. On the one hand, sufficient coherent light is required for generating a holographic reconstruction. However, it is also important in the case of a preferred single parallax encoding of a hologram to avoid disturbing interference effects in a sweet spot direction in the case of a partial decoupling of light by different partially-reflective decoupling elements. The sweet spot direction is the non-encoding direction of a one-dimensional hologram, if a single parallax encoding is provided with respect to the spatial light modulator device. This means that a sweet spot is generated in the non-encoding direction, where a virtual observer region is generated in the encoding direction of the one-dimensional hologram, through which an observer can observe a reconstructed three-dimensional scene.

In one embodiment of the invention, it can furthermore be provided that the coherence length of the light is set in such a way that the coherence length is less than the shortest distance of two partially-reflective decoupling elements from one another in the at least one light guide. The coherence length of the light emitted by the at least one illumination device can be adapted in such a way that light which originates from the same pixel or the same pixel column in the case of a vertical encoding direction or pixel row in the case of a horizontal encoding direction, respectively, with respect to a single parallax encoding and is coupled out by the same partially-reflective decoupling element of the light guide is coherent in relation to one another, where light which does originate from this pixel or this pixel column or this pixel row, respectively, but additionally is coupled out by the adjacent or a different partially-reflective decoupling element of the light guide, is incoherent in relation to one another.

To achieve this, the coherence length of the light l_{K}

$${l}_{K} = \frac{{λ}^{2}}{Δ λ}$$

is advantageously selected in such a way that the coherence length is less than the shortest distance between two partially-reflective decoupling elements in the light guide. λ is the wavelength of the light emitted by the illumination device and Δλ is the spectral width of at least one light source of the illumination device. The shortest distance between two partially-reflective decoupling elements in the light guide is the connecting line perpendicular to the surface of the partially-reflective decoupling elements Δm. The setting of the coherence length of the light is for example performed by selecting a light source having sufficient spectral width Δλ. In order that the coherence length of the light is less than Δm, the spectral width thus has to be greater than a specific Δλ:

l_{K}≤Δm;Δλ≥λ²/Δm.

For example, for a distance of the decoupling elements of approximately 3 mm and a light wavelength A of 532 nm, therefore green light, a spectral width of Δλ (532 nm)²/3 mm results.

The spectral width Δλ of the light source used in the illumination device is to be greater than or equal to approximately 0.1 nm in this case. A light source, for example, a laser, having a sufficiently large line width of ≥0.1 is therefore to be selected. This is only to be regarded as an example, where other distances of the decoupling elements and other wavelengths of the light used are also possible, of course.

In a further embodiment of the invention, the display device can provide at least one optical component, which in particular comprises a cylinder element. The at least one optical component influences at least the illumination beam path. For a preferred single parallax encoding, it is advantageous if the at least one optical component is or comprises a cylindrical imaging element or has a different focal length in the encoding direction and in the non-encoding direction. It is also possible to use and to combine multiple optical components, which form an optical system. For this purpose, in the case of a single parallax encoding, at least one optical component is to be formed cylindrical or is to have a different focal length in the encoding direction and in the non-encoding direction. This optical component is thus provided to generate horizontal images and vertical images of at least one light source of the illumination device in various planes.

For this purpose, it is advantageous if the at least one optical component is arranged in the light path immediately after the at least one spatial light modulator device, so that it has no influence on the image position of the spatial light modulator device. Immediately after the at least one spatial light modulator device is to mean here that the distance between the spatial light modulator device and the optical component is very small, ideally zero. This distance is to be very much less than the focal length of the optical component, preferably less than 10% of the focal length. If the optical component is, for example, a lens element having a focal length of 100 mm, the distance between the spatial light modulator device and the optical component is thus preferably to be less than 10 mm.

For example, the display device according to the invention can also comprise, instead of individual lens elements, a projection system, for example, a system made of many lens elements, for imaging the spatial light modulator device. The projection system comprises in this case its exit pupil on the coupling side of the at least one light guide in one direction, for example, in the horizontal direction. In a direction perpendicular thereto, for example, the vertical direction, the exit pupil of the projection system is located in the light path after the coupling of the light out of the at least one light guide. In the case of a collimated illumination of the spatial light modulator device by means of a sufficiently coherent light source in the encoding direction, the projection system then generates a virtual observer region in the light direction after the coupling of the light out of the at least one light guide in the plane of the exit pupil.

In one advantageous embodiment of the invention, it can be provided that a virtual observer region is generatable in a Fourier plane or in an image plane of the at least one spatial light modulator device at least in one encoding direction of the hologram and in the light direction after the at least one light guide. If a preferred single parallax encoding of a hologram is provided in the at least one spatial light modulator device, a sweet spot is then generatable in a non-encoding direction of the hologram in the light path after the coupling out of the light guide. The virtual observer region is thus advantageously provided in the encoding direction of the hologram in a Fourier plane of the spatial light modulator device. This plane, in which the Fourier transform of the hologram results, also corresponds in this case to the plane of the light source image if no hologram is written or encoded in the spatial light modulator device. The image of the light source is generated in this case after the coupling of the light out of the light guide at a defined distance from the light guide, for example, at a distance of approximately 35 mm. In other words, a light source image of at least one light source of the at least one illumination device can be generated in the light path after a coupling of the light out of the at least one light guide at the position of a virtual observer region in the encoding direction. This means that a virtual observer region can be generated in a plane of the light source image or in a plane of an image of the spatial light modulator device.

In a non-encoding direction perpendicular thereto, if a preferred single parallax encoding of a hologram is provided in the at least one spatial light modulator device, a light source image of at least one light source of the at least one illumination device is generatable in the light path at or close to a coupling position of the light into the light guide. In other words, a one-dimensional light source image, if no hologram is written or encoded in the spatial light modulator device, is located at or close to the coupling position of the light into the light guide.

The at least one optical component can advantageously be provided for generating a horizontal light source image and a vertical light source image, where the light source images result at different positions in the beam path. For illustration, it is explained here that the terms “horizontal light source image” and “vertical light source image” are to be understood to mean that, for example, a horizontal image in the form of a vertical line or a vertical image in the form of a horizontal line, respectively, would result from a point light source. This applies if a single parallax encoding of a hologram is performed in the spatial light modulator device of the display device according to the invention. By means of the optical component, which comprises a cylinder function for this purpose, the position of a horizontal light source image to be generated can therefore be selected and generated differently from the position of a vertical light source image to be generated in the beam path.

A virtual observer region can be generated in at least one encoding direction in a plane of a light source image provided in the light direction after the at least one light guide or in a plane of an image of the spatial light modulator device provided in the light direction after the at least one light guide.

In another embodiment of the invention, the virtual observer region can be generated in the encoding direction as an image of the spatial light modulator device. A frustum, in which a three-dimensional scene can be reconstructed, is spanned in this case between a Fourier plane, which is located between the physical or real spatial light modulator device and the image of the spatial light modulator device, and this image of the spatial light modulator device. In this embodiment, the optical component is not located directly at the spatial light modulator device but rather in a Fourier plane of the spatial light modulator device. An image of the at least one spatial light modulator device after a coupling of the light out of the at least one light guide is generated in the encoding direction at the position of a virtual observer region by the imaging elements in this embodiment. The further imaging element after the coupling out of the at least one light guide would in this embodiment influence at least the illumination beam path and would shift the position of the Fourier plane of the at least one spatial light modulator device visible from the observer. However, only conventional embodiments of the invention are to be described hereafter.

If a single parallax hologram encoding is used, for example, a sweet spot is generated in one direction, for example, the horizontal direction, while a virtual observer region is generated in a direction perpendicular thereto, for example, the vertical direction.

Using the light guide having partially-reflective decoupling elements provided in the display device according to the invention, a comparatively large field of view may be achieved in the sweet spot direction, i.e., in the non-encoding direction if a single parallax encoding is used. In the encoding direction of the hologram, however, there is a relationship between the size of the virtual observer region, the light wavelength used, and a required number of pixels of the spatial light modulator device per degree of the field of view. Simulations have shown in this case that, for example, for a virtual observer region of approximately 7 mm, approximately 250 pixels per degree of the field of view are required, the number of pixels is higher for a larger virtual observer region. Because of the limiting of the pixel number of a conventional spatial light modulator device, only a field of view which is small in size of a few degrees may then be generated in the encoding direction. For example, upon use of a spatial light modulator device having HDTV (high-definition television) resolution, i.e., 1920×1080 pixels, if this spatial light modulator device is aligned in portrait arrangement, i.e., having the longer side in the vertical direction, a vertical field of view of approximately 8° (1920 pixels/250 pixels per degree) may be generated for a virtual observer region of approximately 7 mm.

In one particularly advantageous embodiment of the invention, it can therefore be provided that a deflection device is provided for enlarging a field of view in a horizontal and/or vertical direction. In this manner, the horizontal and/or vertical field of view can be enlarged. The enlargement of the field of view is performed for this purpose via tiling and/or segmenting, preferably time-sequential tiling. This means the field of view is enlarged by juxtaposing multiple tiles or segments of the imaged spatial light modulator device.

For this purpose, the deflection device can advantageously comprise at least two deflection elements, of which at least one deflection element is designed as switchable, where the deflection elements are preferably designed as grating elements or mirror elements or redirection elements.

One of the at least two deflection elements can be designed as a redirection element, which comprises at least one mirror element, preferably a wire grid polarizer, and at least one polarization switch, and another of the at least two deflection elements can be designed as a mirror element.

With respect to a preferred single parallax encoding of a hologram in the spatial light modulator device, it is sufficient if the field of view is enlarged in the encoding direction, since a large field of view can already be generated in the non-encoding direction by generating a sweet spot. This means that a large field of view can already be achieved using a single tile or segment in the non-encoding direction. In the encoding direction of the hologram, however, the field of view is restricted by the ratio of the size of the virtual observer region to the field of view of a tile or a segment. It can therefore be advantageous to enlarge the field of view in the encoding direction to be able to represent large reconstructed objects or scenes.

A vertical and/or horizontal offset, depending on which direction(s) is/are the encoding direction(s), may advantageously be provided in the optical beam path before a coupling of the light into the at least one light guide by means of the at least two deflection elements of the deflection device, so that the light of the individual tiles or segments is coupled into the light guide at different heights or widths. In other words, the at least two imaging elements of the deflection device can be situated offset in relation to one another in the light direction before the at least one light guide to displace the coupling location of the light into the at least one light guide.

To generate a vertical and/or horizontal offset of the light in a coupling plane of the at least one light guide, in which the light is coupled into the light guide, for example, switchable deflection elements, such as switchable grating elements or other switchable redirection elements, can be used. For example, a wire grid polarizer may be configured in combination with a polarization switch as a switchable redirection element, in particular as a switchable deflection mirror, so that depending on the switching state of the redirection element, in each case one of two or more vertical and/or horizontal tiles or segments can be generated.

In this manner, it can be provided that by means of the at least one light guide and the deflection device, an image of the at least one spatial light modulator device composed of tiles or segments can be generated, where the image defines a field of view within which an item of information or hologram of a scene encoded in the spatial light modulator device can be reconstructed for observation through the virtual observer region in the plane of a light source image.

In another embodiment of the invention, it can be provided that an image of a diffraction order composed of tiles or segments can be generated in a Fourier plane of the spatial light modulator device by means of the at least one light guide and the deflection device, where the image defines a field of view within which an item of information or hologram of a scene encoded in the spatial light modulator device can be reconstructed for observation through a virtual observer region in an image plane of the spatial light modulator device.

Furthermore, it can be provided that the light propagates within the at least one light guide via a reflection on boundary surfaces of the light guide, in particular via total reflection, and where the coupling of light bundles of the light out of the light guide is provided in each case at predefined partially-reflective decoupling elements.

The spatial light modulator device can advantageously be designed as a phase-modulating spatial light modulator device or as a complex-valued spatial light modulator device.

The display device according to the invention can be designed as a head-mounted display or as an augmented-reality display or as a virtual-reality display.

For this purpose, the display device according to the invention comprises, in each case for one eye of an observer, a light source, a spatial light modulator device, at least one imaging element, and a light guide which comprises at least two partially-reflective decoupling elements. The same elements, i.e., the light sources, the spatial light modulator devices, the imaging elements, and the light guides, are preferably arranged in the display device mirror —symmetrically in relation to the nose of the observer.

The object according to the invention is furthermore achieved by a method for representing a reconstructed scene, carried out using a display device as claimed in any one of claims 1 to 34.

There are various options for configuring the teaching of the present invention in an advantageous manner and/or combining the exemplary embodiments and/or configurations described above and below with one another. For this purpose, reference is to be made, on the one hand, to the patent claims depending on the independent patent claims and, on the other hand, to the following explanation of the preferred exemplary embodiments of the invention on the basis of the drawings, in which generally preferred configurations of the teaching are also explained. In this case, the invention is explained in principle on the basis of the described exemplary embodiments however it should not be restricted to these.

In the figures:

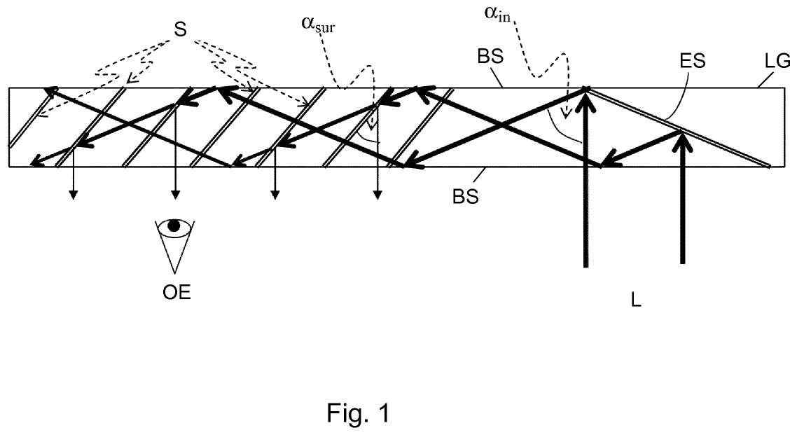

FIG. 1: shows a schematic illustration of a light guide according to the prior art;

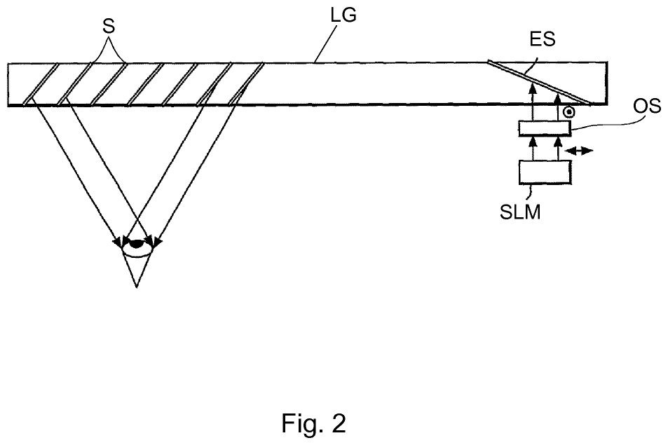

FIG. 2: shows a schematic illustration of an optical device having such a light guide according to FIG. 1 according to the prior art;

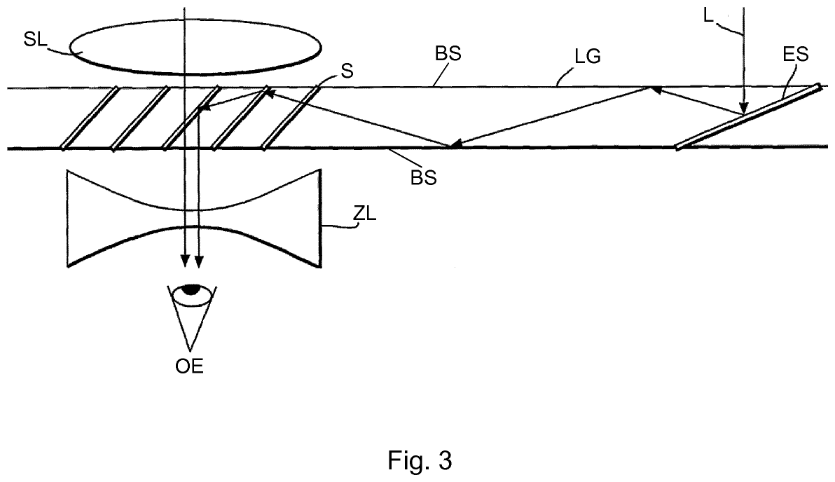

FIG. 3: shows a schematic illustration of an optical device having a light guide according to FIGS. 1 and 2 according to the prior art;

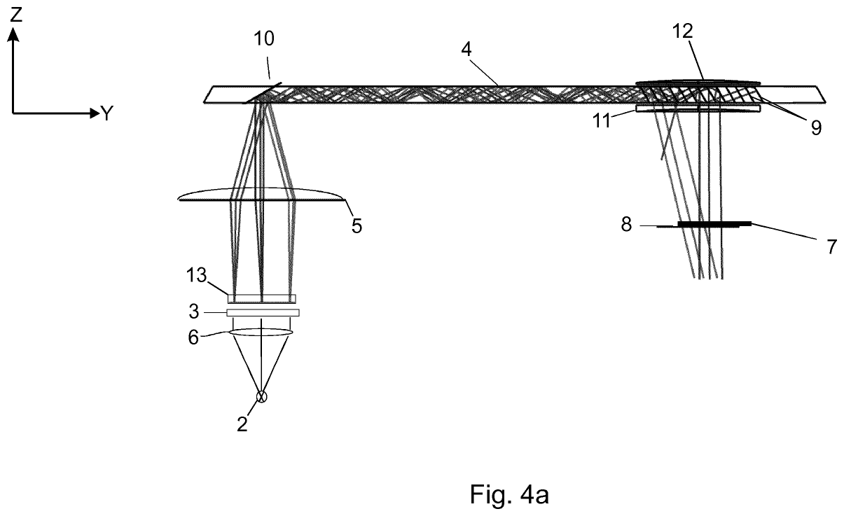

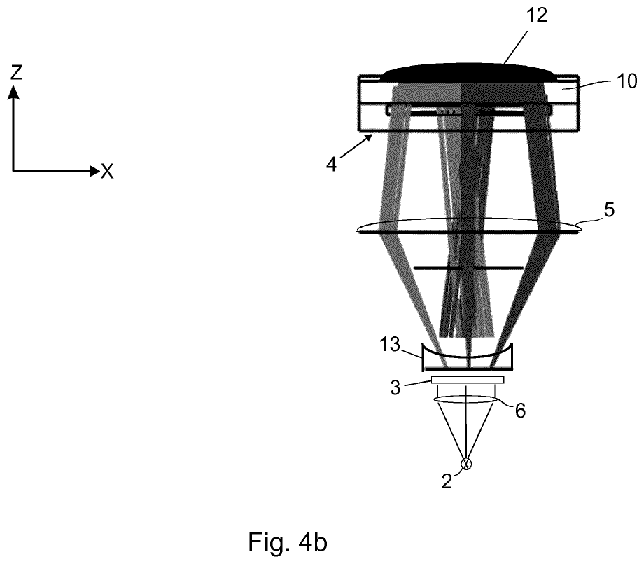

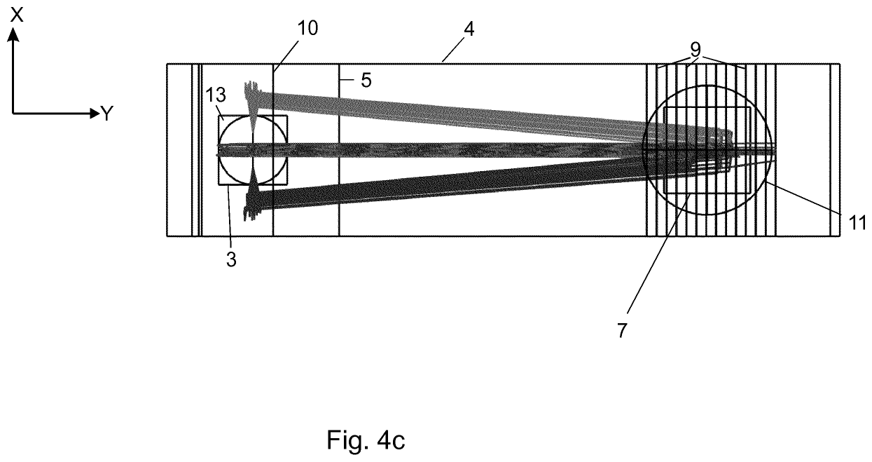

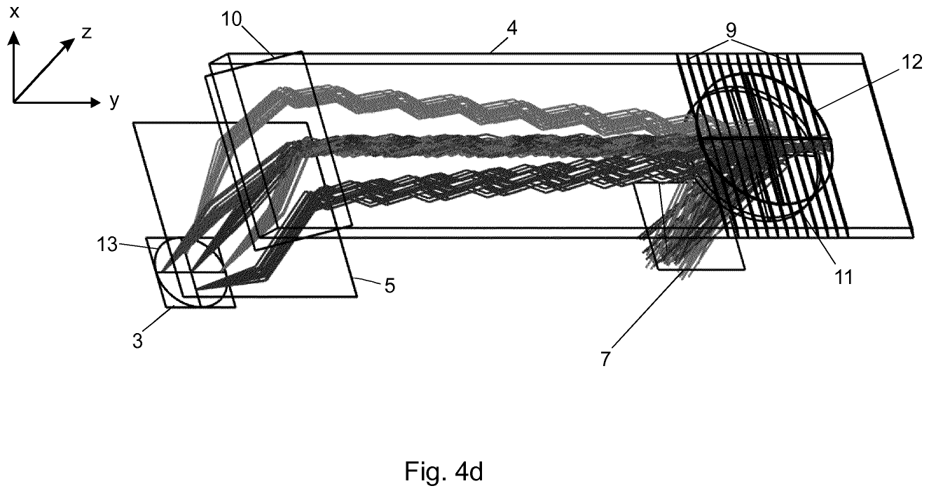

FIG. 4a: shows a schematic illustration of a display device according to the invention in the non-encoding direction if a single parallax encoding is provided;

FIG. 4b: shows the display device according to the invention according to FIG. 4a in a view rotated by 90°;

FIG. 4c: shows the display device according to the invention according to FIGS. 4a and 4b in a view rotated by 90° in relation to FIG. 4b;

FIG. 4d: shows the display device according to the invention according to FIGS. 4a, 4b, and 4c in a perspective view;

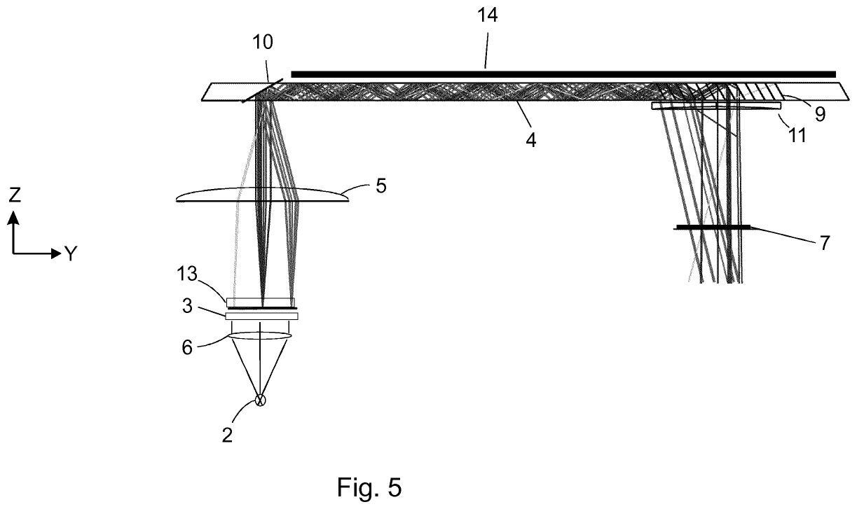

FIG. 5: shows a schematic illustration of a further display device according to the invention in the non-encoding direction if a single parallax encoding is provided;

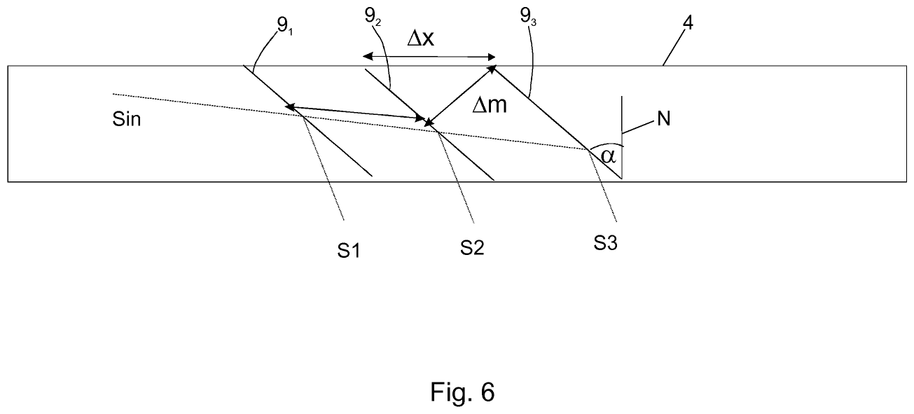

FIG. 6: shows a schematic illustration of a setting of a coherence length of the light used;

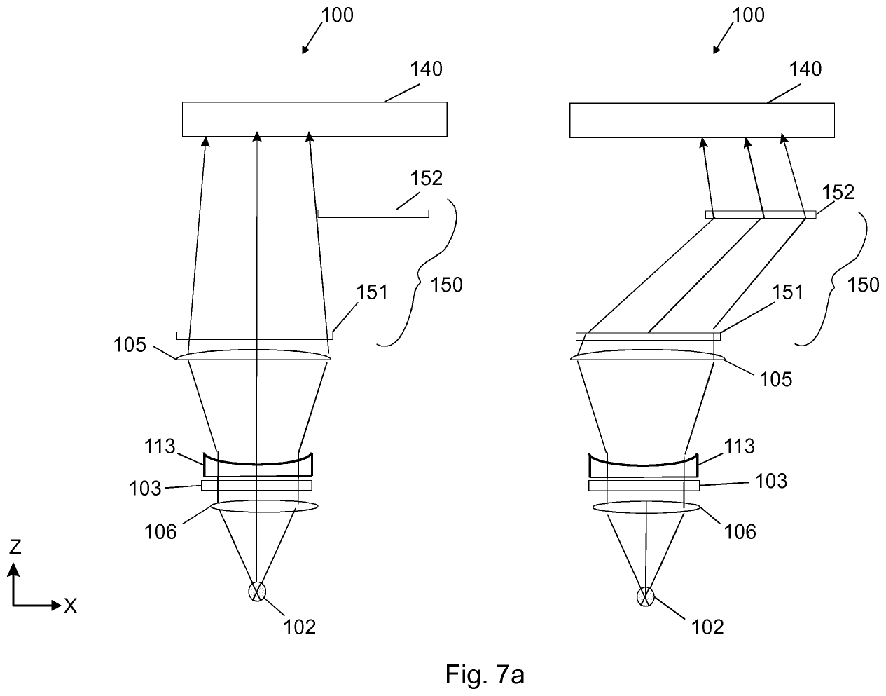

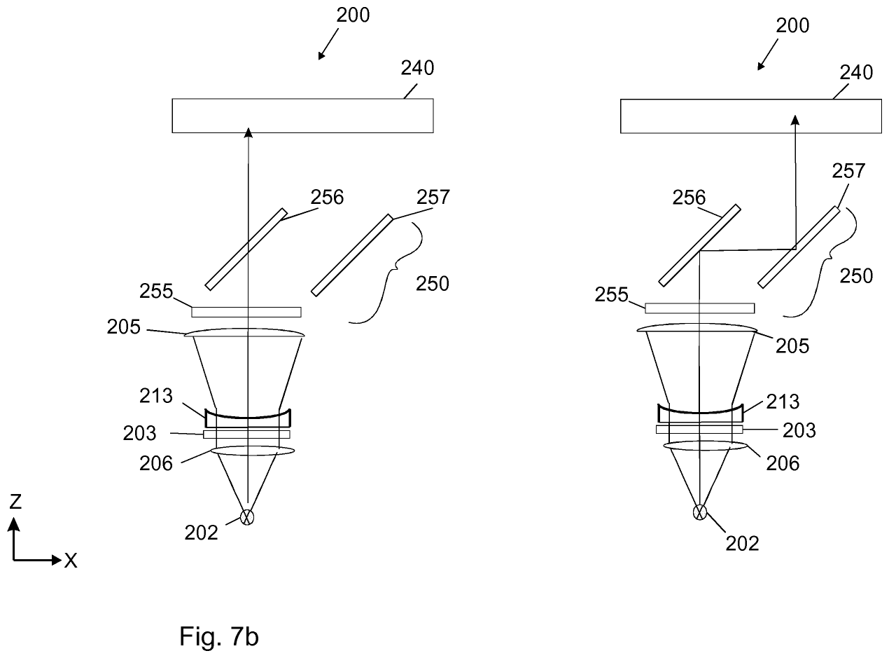

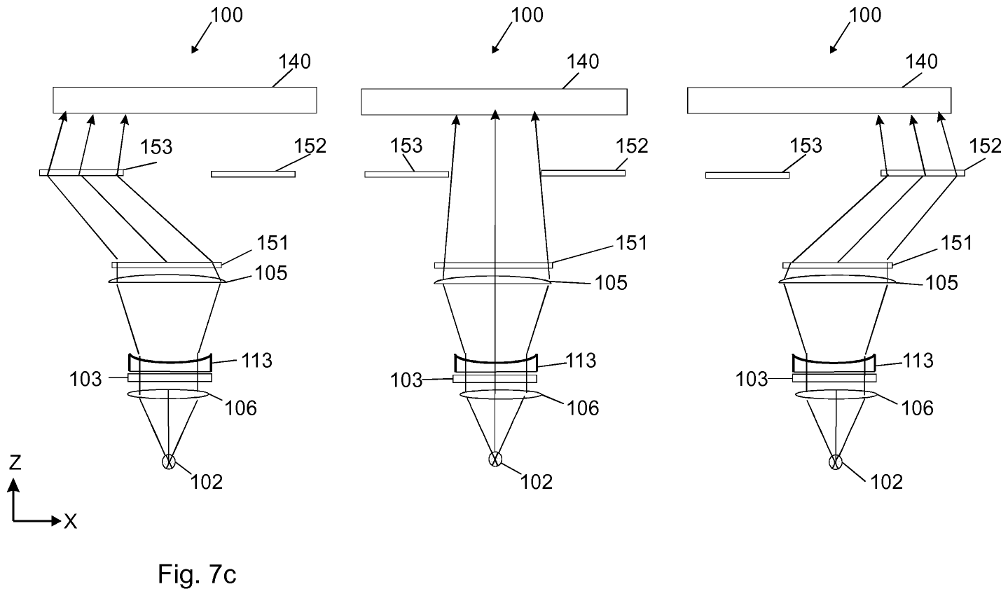

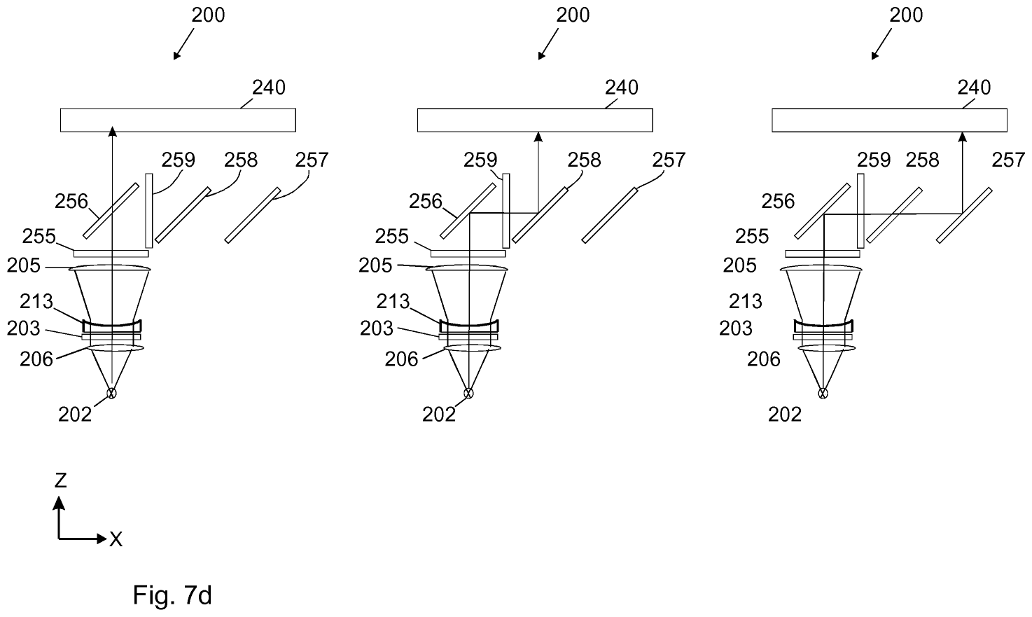

FIG. 7a: shows a schematic illustration of a further embodiment of the display device according to the invention, where grating elements are provided to enlarge a field of view;

FIG. 7b: shows a schematic illustration of a third embodiment of the display device according to the invention, where mirror elements are provided to enlarge a field of view;

FIG. 7c: shows a schematic illustration of the display device according to FIG. 7a, where the field of view is enlarged by means of three generated segments here;

FIG. 7d: shows a schematic illustration of the display device according to FIG. 7b, where the field of view is enlarged by means of three generated segments here;

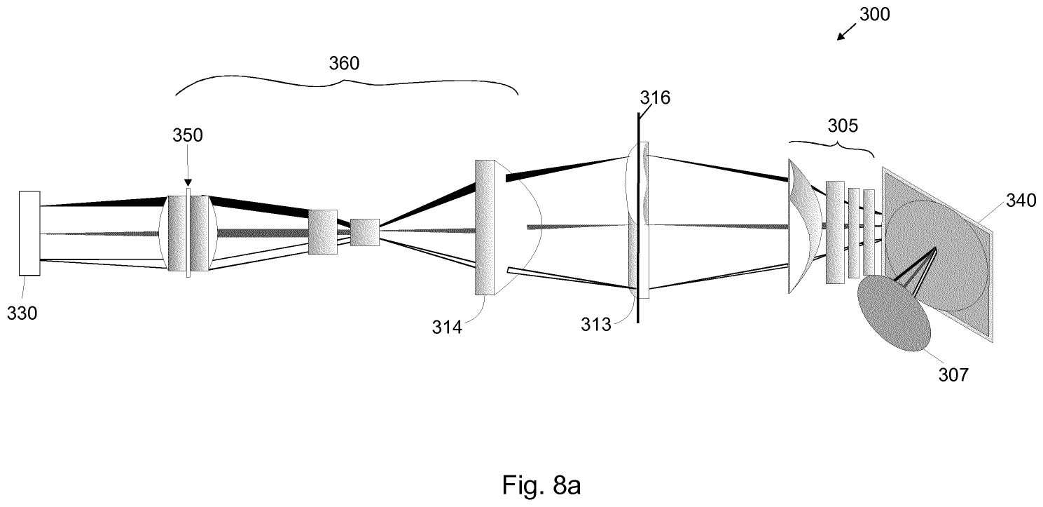

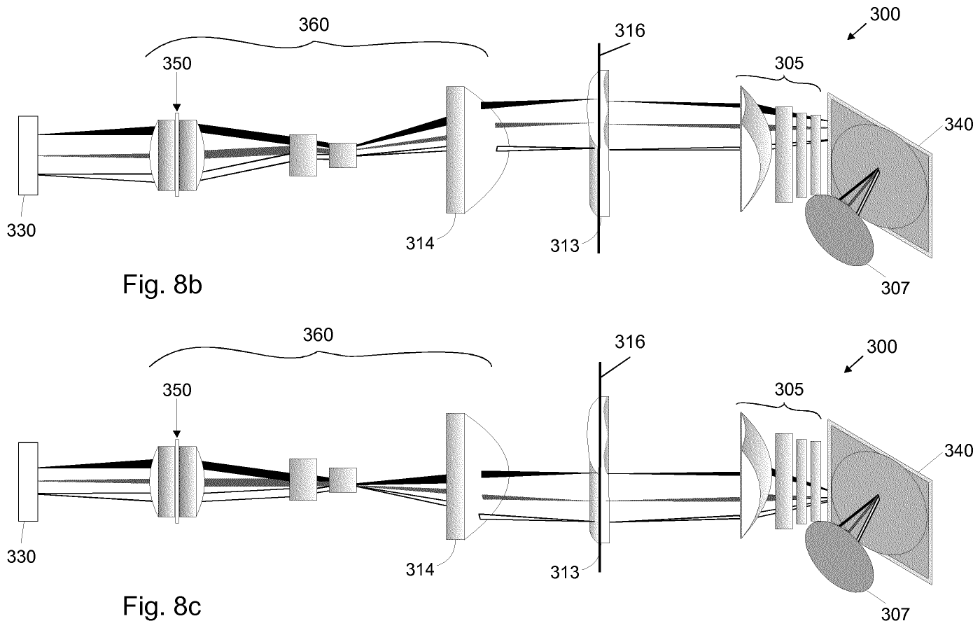

FIG. 8a: shows a schematic illustration of a further display device according to the invention in a perspective view;

FIG. 8b: shows the display device according to FIG. 7a in a side view for the generation of a segment;

FIG. 8c: shows the display device according to FIG. 7a in a side view for the generation of a further segment;

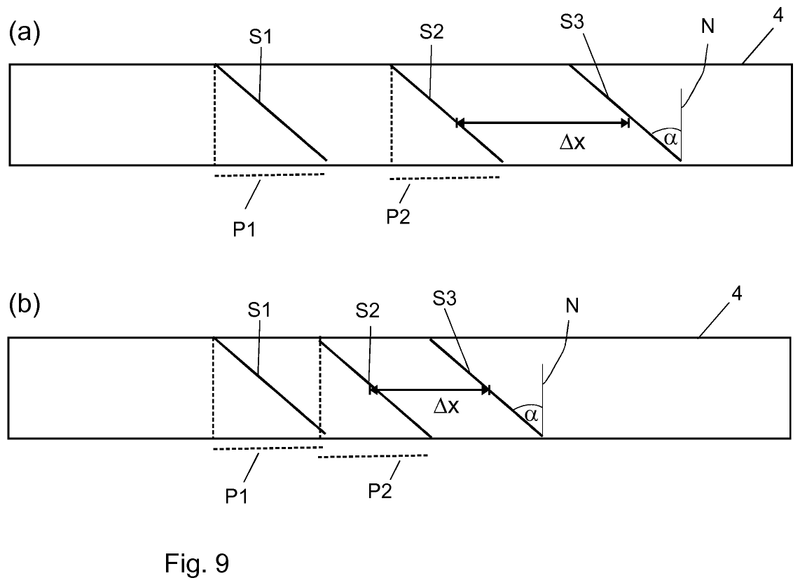

FIG. 9: shows a schematic illustration of a light guide provided in the display device according to the invention in conjunction with the selection of a suitable distance of the decoupling elements from one another;

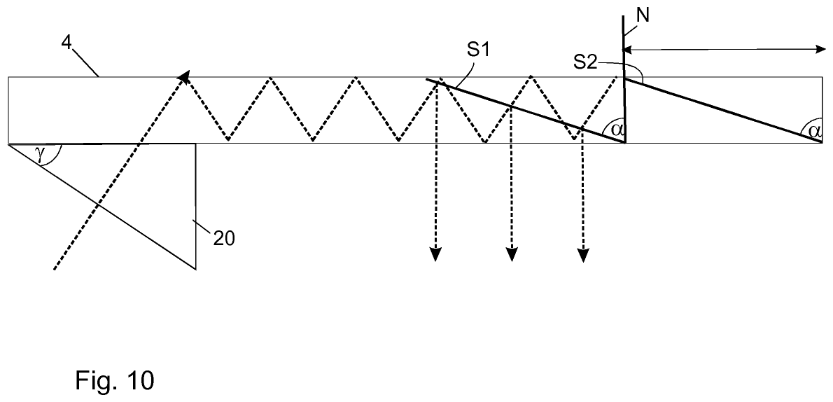

FIG. 10: shows a schematic illustration of a light guide having an advantageous arrangement of the decoupling elements; and

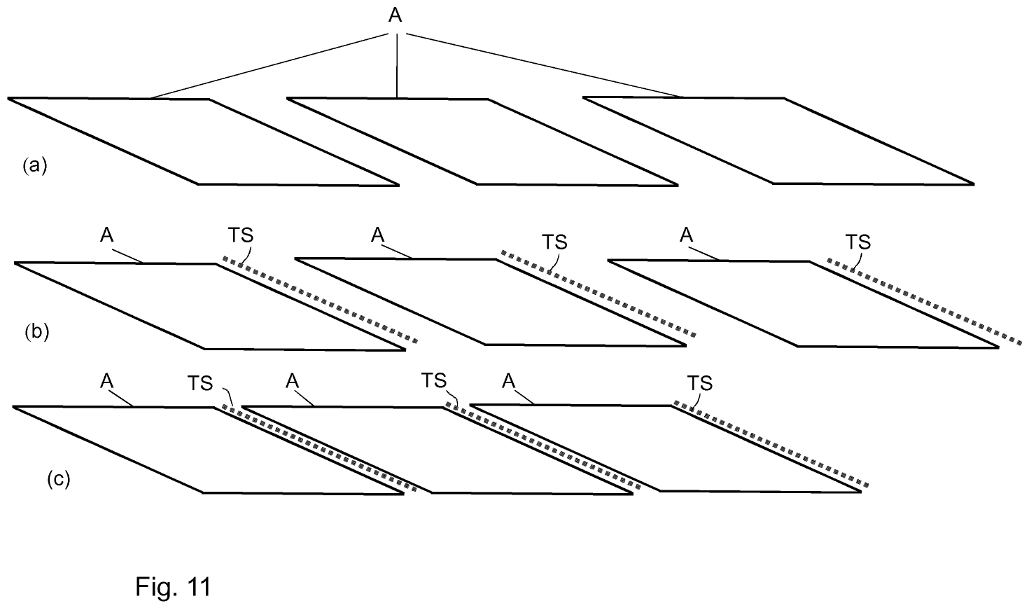

FIG. 11: shows a schematic illustration of the production of a light guide for the display device according to the invention.

It is to be briefly mentioned that identical elements/parts/components also have identical reference signs in the figures.

An optical device having a light guide LG according to the prior art is illustrated in FIG. 1. The light guide LG comprises partially-reflective decoupling elements, in the form of mirror elements S here, for decoupling light propagating in the light guide LG. Furthermore, a coupling element, in the form of a coupling mirror ES here, is provided, which is used for coupling incident light into the light guide LG. The light L emitted by a light source (not shown), illustrated here by black arrows, is incident on the coupling mirror ES and is coupled into the light guide LG thereby. The light or the light beams L propagate in a zigzag and/or via total reflection through the light guide LG, by being alternately reflected on its two inner surfaces or boundary surfaces BS. After several reflections of the light within the light guide LG, the light is incident on an arrangement of mirror elements S, via which the light is coupled out of the light guide LG and directed in the direction of eyes of an observer OE. Depending on whether the propagating light beams or the light was reflected last on the lower surface BS or the upper surface BS of the light guide LG, it is incident at two different angles on the partially-reflective mirror elements S. These mirror elements S are formed in this case in such a way that the mirror elements only act partially reflective for a defined range of angles of incidence of the light, in contrast, for other angles of incidence of the light they act transmissive. In FIG. 1, only the light beams L which are incident from the upper surface BS of the light guide LG on the mirror elements S are partially reflected by the mirror elements S, but not the light beams L which are incident from the lower surface BS of the light guide LG on the mirror elements S.

Due to the selection of the angles of coupling mirror ES and mirror element S in relation to the surface BS of the light guide LG, for the light beams L coupled in perpendicularly to the surface BS, the light beams coupled out by the mirror elements S are parallel to the coupled-in light beams.

FIG. 2 schematically illustrates an optical device having a light guide LG shown according to FIG. 1. A field of view is illustrated in this FIG. 2, which can be generated using such a light guide LG having partially-reflective mirror elements S. An angular spectrum of the light for the field of view to be generated is coupled into the light guide LG by means of a light modulator SLM, an optical unit OS, and a coupling mirror ES. The arrangement of partially-reflective mirror elements S couples out the light propagating in the light guide LG. If an observer is located at a distance from the light guide LG, a field of view is thus spanned by light which is coupled out at different angles at the various mirror segments S and reaches an eye of the observer. The extension of the generated sweet spot is also to be taken into consideration in the size of the field of view. In the case of FIG. 2, the sweet spot is generated, for example, for the first angle in the field of view by light being coupled out by the first two partially-reflective mirror elements S and for the second angle in the field of view by light being coupled out by the last two mirror elements S. The field of view is then formed, for example, in that the light from the first mirror element viewed from the left side reaches the left edge of the sweet spot at a first angle or reaches the same left edge of the sweet spot at a second angle from the next-to-last mirror element.

However, it can be problematic for a holographic display device if parallel light beams which originate from the same pixel of a spatial light modulator device are coupled out at different mirror elements after they have passed through paths of different lengths in the light guide, and if these light beams then reach the eye of an observer. In the case of coherent light, undesired appearances of interference can then occur between the individual light beams originating from the same pixel. In the case of FIG. 2, for example, light which is coupled out of the same pixel at the same first angle at the first and at the second mirror element would interfere in the sweet spot.

An optical device having a light guide according to FIG. 1 is also illustrated in FIG. 3. As already mentioned, the light guide LG comprises partially-reflective mirror elements S, where the optical device in FIG. 3 now also comprises additional lens elements. On the right hand of the illustration in FIG. 3, light L is coupled by means of the coupling mirror ES into the light guide LG. The light then propagates under total reflection in the light guide LG by being reflected on its surfaces BS.

On the left hand of this FIG. 3, the arrangement of multiple partially-reflective mirror elements S is again arranged, using which the light propagating in the light guide LG can be coupled out. As is apparent, a diverging lens ZL, which can also be referred to as a concave lens, is arranged between the light guide LG and the eye OE of an observer. A converging lens SL, which can also be referred to as a convex lens, is arranged on the opposing side of the light guide LG.

The light beams which are coupled out of the light guide by means of the partially-reflective mirror elements S only pass through the diverging lens ZL in the light path to the eye of the observer. Light beams which originate from the other side of the light guide LG, for example, light beams which originate from the natural surroundings, pass through the converging lens SL in the light path to the eye of the observer and also pass through the diverging lens ZL after passage through the light guide LG.

A display device 1, in particular a holographic display device, is illustrated in FIGS. 4a to 4d, which comprises a light guide which is described according to FIGS. 1 to 3. This exemplary embodiment is described with respect to a single parallax encoding of a hologram in a spatial light modulator device.

In this case, the display device 1 is illustrated according to a section in the YZ plane in FIG. 4a. The display device 1 comprises an illumination device 2, which comprises at least one light source, a spatial light modulator device 3, which is referred to hereafter as an SLM, a light guide 4, and at least one imaging element 5. The illumination device 2 is designed so as to emit sufficient coherent light. A hologram can be encoded in the SLM 3 to holographically reconstruct a preferably three-dimensional scene. The encoding of the hologram in the SLM 3 can be carried out as full parallax encoding or as single parallax encoding. The display device according to the invention is described hereafter for a single parallax encoding of a hologram on the SLM 3, where the invention is not to be restricted to a single parallax encoding, but rather is also usable for a full parallax encoding. In the case of a single parallax encoding, only a one-dimensional hologram is encoded in the SLM 3. Light can thus pass through the display device in the encoding direction of the hologram and in the non-encoding direction.

An illumination optical unit 6 is provided between the illumination device 2 and the SLM 3, using which the SLM 3 is preferably illuminated using collimated light. The light beam angle in the light path after the SLM 3 is then determined in the encoding direction by the diffraction at the pixel aperture of the SLM 3. Perpendicular to the encoding direction, i.e., in the non-encoding direction, a defined minimum beam angle is required to generate a sweet spot 7 in an observer plane 8. This beam angle is preferably selected so that the light from every pixel of the SLM 3 in the light path in the non-encoding direction fills up the area of a light coupling device 10. In the case of FIG. 4a, the light is shown originating from three pixels of the SLM 3. The light of the respective pixels is divergent in the light path between the SLM 3 and the imaging element 5. In the light path between the imaging element 5 and the light coupling device 10, it is collimated. To fill up the area of the light coupling device 10, the diameter of the beam bundle from the respective pixels on the imaging element 5 is to correspond to the projection of the light coupling device 10 on the lower side of the light guide 4. The required angle thus results from the distance between the SLM 3 and the imaging element 5 and also the size of the light coupling device 10. In the exemplary embodiment illustrated in FIG. 4a, the beam angle in order to fill up the area of the light coupling device 10 is approximately ±8°. Solely for illustration, so that the light coupling device can be seen better, however, a smaller angle has been used in FIG. 4a, i.e., the light coupling device 10 is not filled up in FIG. 4a.

The generation of this beam angle can be carried out as follows: Optionally, a one-dimensional scattering element, which generates this defined beam angle, can be provided on the SLM 3 or in the vicinity of the SLM 3 or in general in other specific embodiments also in an image plane of the SLM 3. It is alternatively also possible that the illumination of the SLM 3 is only performed in the encoding direction using collimated light and is performed in the non-encoding direction perpendicular thereto using an angular spectrum which approximately corresponds to the minimum beam angle or is slightly greater.

The SLM 3 can alternately be designed as a transmissive SLM or as a reflective SLM. In FIG. 4a, the display device 1 comprises a transmissive SLM. The SLM 3 can preferably be a phase-modulating SLM or a complex-valued SLM, which modulates the phase and amplitude of the light. However, the invention is not restricted to these cases, but rather the SLM 3 can also be an amplitude-modulating SLM. In the embodiment of the display device 1 according to FIG. 4a, single parallax holograms are written or encoded in the SLM 3 in the direction perpendicular to the plane of the paper, i.e., the X direction.

The light guide 4 comprises partially-reflective decoupling elements 9 for coupling out light beams or light propagating in the light guide 4. The partially-reflective decoupling elements 9 are parallel in relation to one another in the light guide 4. Moreover, the partially-reflective decoupling elements 9 are arranged at a defined distance in relation to one another in the light guide 4. It is ensured in this way that the light propagating in the light guide 4 is also coupled out of the light guide 4 at the decoupling elements 9 provided for this purpose.

The imaging element 5, which can be designed as a lens element, a mirror element, or also as a grating element, is provided in the light path between the SLM 3 and the light guide 4. In the general case, it can also be an imaging system having at least two or more imaging elements. The statements made in this document on the focal length and specific distances with respect to the imaging element 5 then apply to the total focal lengths and the principal planes of the imaging system.

As is apparent from FIG. 4a, the light is emitted from various pixels of the SLM 3, only from three different pixels of the SLM 3 in this exemplary embodiment here for reasons of clarity, where the SLM 3 modulates the light emitted by the illumination device 2 in accordance with the information of the object or scene to be reconstructed and represented. The imaging element 5 is arranged at the distance of its focal length from the SLM 3 in the display device 1. In this manner, the imaging element 5 can generate an image of the SLM 3 in infinity. This means that light beams which originate from the same pixel of the SLM 3 are collimated and/or extend parallel in relation to one another in the light path after the imaging element 5. However, the light beams which originate from different pixels of the SLM have different angles in relation to one another in the light direction after the imaging element 5.

Furthermore, the display device 1 comprises the light coupling device 10, using which the light incident on the light guide 4 can be coupled into the light guide 4. This light coupling device 10 comprises at least one mirror element and/or at least one grating element and/or at least one prism element for coupling the light into the light guide 4. In FIG. 4a, the light coupling device 10 comprises a mirror element for coupling the light into the light guide 4. The imaging element 5 moreover images the light source of the illumination device 2 in the illustrated YZ plane of FIG. 4a on the mirror element of the light coupling device 10 or in the general case in the vicinity of the light coupling device 10 of the light guide 4. The light beams which originate from various pixels of the SLM 3 are thus completely or at least substantially superimposed on one another on the mirror element of the light coupling device 10.

The coupled-in angular spectrum of the light, which essentially corresponds to the field of view in the Y direction, is defined by the light beams which originate from the edge pixels of the SLM 3 in the perpendicular direction, pass or pass through the imaging element 5, and are incident on the mirror element of the light coupling device 10, where the Y direction corresponds to the horizontal direction here.

For example, it would also be possible that the display device 1 comprises a projection system for imaging the SLM, where the projection system has its exit pupil on the light coupling side of the light guide 4 in one direction and, in a direction perpendicular thereto, the exit pupil of the projection system is located in the light path after the coupling of the light out of the light guide 4. Upon illumination of the SLM using collimated light beams by means of a sufficiently coherent light source of the illumination device, a virtual observer region is moreover generated in the encoding direction in the case of a single parallax encoding in the plane of the exit pupil of the projection system.

After the incidence of the light beams on the light coupling device 10, they are coupled by means of the mirror element of the light coupling device 10 into the light guide 4. The light beams then propagate in the light guide 4 via total reflection and/or are reflected at the boundary surfaces or surfaces of the light guide 4 and coupled out of the light guide 4 by means of the arrangement of partially-reflective decoupling elements 9. In general, the decoupling of light which originates from the same pixel takes place at multiple different decoupling elements. The light which originates from different pixels of the SLM 3 is coupled out of the light guide 4 at different angles. This takes place in parallel to the coupling angles of the light beams in each case. The coupling angle of the light thus corresponds to the decoupling angle of the light. The light which originates from various pixels of the SLM 3 then passes the sweet spot 7 in the light path. A sweet spot 7 is thus generated in the observer plane 8 in the non-encoding direction of the hologram, whereby a large field of view can be achieved in the non-encoding direction, the Y direction here.

The display device 1 moreover comprises a further imaging element 11. The further imaging element 11 can comprise at least one lens element, at least one imaging element having variable focal length, and/or at least one switchable imaging element. The further imaging element 11 is arranged in the light direction after the light guide 4 and/or between the light guide 4 and the observer plane 8, in which an observer can be located, to observe a reconstructed three-dimensional object or scene. This further imaging element 11 is designed as a concave imaging element or concave imaging system, which comprises at least two imaging elements. The image of the SLM 3, which is located in infinity, can again be displaced or moved into a finite distance in relation to an observer using this further imaging element 11 between the coupling of the light out of the light guide 4 and the sweet spot 7 in the non-encoding direction or a virtual observer region in the encoding direction of the hologram, respectively.

The further concave imaging element 11 provided between the light guide 4 and an observer can thus be used to set the image position of the SLM 3, as is seen from the eye. If an image of the SLM 3 is generated in infinity by the optical system or the imaging element 5 in the light path before the coupling of the light into the light guide 4, the further concave imaging element 11 in the light path between the light guide 4 and the observer thus displaces the location of the image of the SLM 3 into a finite distance in relation to the observer. For example, a further imaging element having a focal length of f=−2 m would move or displace the image of the SLM toward the observer from an infinite distance to a finite distance of 2 m.

The effect of this further concave imaging element 11 on the ambient light, i.e., the light which enters from the surroundings of the display device 1 if the display device is embodied as an augmented-reality display into the light guide 4 in the region of the compensation element 12 and passes through it and the further imaging element 11, can be compensated for by means of a compensation element 12, which is arranged on the side of the light guide 4 opposite to the further imaging element 11. If the display device 1 is used solely as a head-mounted display or as a virtual-reality display, such a compensation element in the display device is not necessary and can thus be omitted. Reference is made in this regard to FIG. 5, in which this case is shown.

The light from the natural surroundings of the display device 1, which passes through both the compensation element 12 and also the further imaging element 11, is not to be changed in the distance in relation to the observer. If the compensation element 12 has a focal length of f=+2 m, i.e., of the same absolute value but opposite sign as the further imaging element 11 in the above-mentioned numeric example, the compensation element 12 and the further imaging element 11 work together like an imaging element having infinite focal length if the distance thereof in relation to one another is small. Both elements 11 and 12 thus leave unchanged the distance from objects in the natural surroundings of the display device 1 visible to the eye of an observer. Optionally, the compensation element can also be adapted to a correction of the visual defect or visual impairment of the respective observer, if the function of spectacles is integrated into the augmented-reality display or into the display device, respectively, of FIG. 5.

FIG. 4a also shows that the display device 1 comprises an optical component 13, which is designed here as a cylinder element. The optical component 13 is situated close to or in the vicinity of the SLM 3. This optical component 13 does not have a focusing effect in the illustrated YZ plane. However, this optical component 13 has a focusing effect in the plane perpendicular to the YZ plane. Because of its position close to or in the vicinity of the SLM 3, the optical component 13 thus has no influence on the image position of the SLM 3.

In the example shown, the angles of inclination of the light coupling device and the decoupling elements in relation to the surfaces of the light guide are selected so that a light beam which is coupled in at a specific angle is also coupled out again at the same angle.

It would also be possible to use a light guide in the display device in which the decoupled light beams are not parallel to the coupled-in light beams, for example, by way of a different orientation of the angle of inclination of the decoupling elements. However, the condition is that there is a unique assignment of a coupling angle of the light to a decoupling angle of the light. For example, the same coupling angle of the light cannot result in two different decoupling angles of the light; and also two different coupling angles of the light cannot result in the same decoupling angle of the light.

A view of the display device 1 shown in FIG. 4a rotated by 90° is illustrated in FIG. 4b. This view rotated by 90° in the XZ plane illustrates the mode of operation of the optical component 13. Light beams are again shown, which originate from three different pixels of the SLM 3, after the SLM 3 has been illuminated by the illumination device 3 using sufficient coherent light. The two outer pixels or light beams shown, which originate from the SLM 3 in the direction of the light guide 4, are different pixels or light beams than the pixels or light beams according to FIG. 4a, where the middle pixel or the middle light beam corresponds to the middle pixel or light beam, respectively, in FIG. 4a, as can be seen unambiguously from the perspective illustration of the display device 1 according to FIG. 4d. The optical component 13 has a widening effect, so that the distance of light beams which originate from the outer pixels or of pixels in the edge region of the SLM 3 in relation to one another is initially enlarged in the light direction after the optical component 13, before this distance of the light beams is reduced again after passing through the imaging element 5, which has a spherical effect here, for the imaging of the SLM 3. The light is then incident on the light coupling device 10 and is coupled thereby into the light guide 4. The coupled-in light propagates in the light guide 4 and is coupled out of the light guide 4 again by the partially-reflective decoupling elements 9, as is described with respect to FIG. 4a.

The display device 1 is illustrated in a section through the XY plane in FIG. 4c. The same three pixels of the SLM 3 are shown here as in FIG. 4b. For reasons of comprehensibility, only the propagation of the light in the light guide 4 is shown, while in contrast the propagation of the light after the coupling out of the light guide 4 is not shown.

In this case, the combination of the focal lengths of diverging optical component 13 and the spherical imaging element 5 is selected in such a way that an image of the light source of the illumination device 2 and thus a superposition of the light beams from the various pixels of the SLM 3 only results in the X direction, i.e., according to the single parallax encoding in the encoding direction, which corresponds here to the X direction or the vertical direction, after the coupling of the light out of the light guide 4 at the position of a sweet spot in the horizontal direction, which corresponds here to the non-encoding direction of the hologram, and at the position of an observer region in the vertical direction.

The display device 1 is illustrated in a perspective view in FIG. 4d. It is shown here that light beams modulated with information of an object or a scene originate from five pixels of the SLM 3. It can be seen once again clearly in this FIG. 4d that in the horizontal direction, i.e., here in the non-encoding direction or in the Y direction, the light from various pixels of the SLM 3 is superimposed at the light coupling device 10 into the light guide 4. In the vertical direction, thus the encoding direction or the X direction, the light of various pixels of the SLM 3 is only superimposed at a greater distance from the SLM 3 after the coupling out of the light guide 4. For reasons of comprehensibility, however, light beams coupled out of the light guide 4 are only illustrated for one of the pixels of the SLM 3.

The display device 1 of FIGS. 4a to 4d is designed as an augmented-reality display (AR display).

A display device which is designed as a virtual-reality display (VR display) is shown in FIG. 5. This display device is designed similarly to the display device 1 illustrated in FIGS. 4a to 4d and also comprises a light guide 4, which is described according to FIGS. 1 to 3. This exemplary embodiment is also described with respect to a single parallax encoding of a hologram in a spatial light modulator device.

The display device is also illustrated here according to a section in the YZ plane. The display device comprises the same elements as the display device 1 of FIGS. 4a to 4d. In other words, the display device comprises the illumination device 2, which comprises at least one light source, the SLM 3, the light guide 4, and at least one imaging element 5. The illumination device 2 is again designed so as to emit sufficient coherent light. A hologram can be encoded in the SLM 3 to reconstruct a preferably three-dimensional scene holographically. The encoding of the hologram SLM 3 can be performed as full parallax encoding or as single parallax encoding. This exemplary embodiment is also described on the basis of a single parallax encoding of a hologram on the SLM 3, where the invention is not to be restricted to a single parallax encoding, but rather is also usable for a full parallax encoding.

The illumination optical unit 6, using which the SLM 3 is preferably illuminated using collimated light, is provided between the illumination device 2 and the SLM 3. The light beam angle in the light path after the SLM 3 is then defined in the encoding direction by the diffraction at the pixel aperture of the SLM 3. Perpendicular to the encoding direction, i.e., in the non-encoding direction, a defined minimum beam angle is required to generate a sweet spot 7 in an observer plane 8. This beam angle is preferably selected so that the light from every pixel of the SLM 3 in the light path in the non-encoding direction fills up the area of a light coupling device 10. In the case of FIG. 5, the light is shown originating from three pixels of the SLM 3. The light from the respective pixels is divergent in the light path between the SLM 3 and the imaging element 5. It is collimated in the light path between the imaging element 5 and the light coupling device 10. To fill up the area of the light coupling device 10, the diameter of the beam bundle from the respective pixels on the imaging element 5 is to correspond to the projection of the light coupling device 10 on the lower side of the light guide 4. The required angle thus results from the distance between the SLM 3 and the imaging element 5 and also the size of the light coupling device 10. In the exemplary embodiment illustrated in FIG. 5, the beam angle to fill up the area of the light coupling device 10 is approximately ±8°. However, a smaller angle has been used in FIG. 5 solely for illustration, so that the light coupling device can be seen better, i.e., the light coupling device 10 is not filled up in FIG. 5.

The generation of this beam angle can be carried out as follows: Optionally, a one-dimensional scattering element, which generates this defined beam angle, can be provided on the SLM 3 or in the vicinity of the SLM 3 or in general in other specific embodiments also in an image plane of the SLM 3. It is alternatively also possible that the illumination of the SLM 3 only takes place in the encoding direction using collimated light and takes place in the non-encoding direction perpendicular thereto using an angular spectrum which approximately corresponds to the minimum beam angle or is slightly greater.

The SLM 3 can also alternately be designed here as a transmissive SLM or as a reflective SLM. In FIG. 5, the display device comprises a transmissive SLM. The SLM 3 can preferably be a phase-modulating SLM or a complex-valued SLM, which modulates the phase and the amplitude of the light. However, the invention is not restricted to these cases, but rather the SLM 3 can also be an amplitude-modulating SLM. In this embodiment of the display device, single parallax holograms are written or encoded in the SLM 3 in the direction perpendicular to the plane of the paper, i.e., the X direction.

The light guide 4 comprises the partially-reflective decoupling elements 9 for coupling light beams or light out propagating in the light guide 4. The partially-reflective decoupling elements 9 are parallel in relation to one another in the light guide 4. Moreover, the partially-reflective decoupling elements 9 are arranged at a defined distance in relation to one another in the light guide 4. In this manner, it is ensured that the light propagating in the light guide 4 is also coupled out of the light guide 4 at the decoupling elements 9 provided for this purpose.

The imaging element 5, which can be designed as a lens element, a mirror element, or also as a grating element, is provided in the light path between the SLM 3 and the light guide 4. In the general case, it can also be an imaging system having at least two or more imaging elements. The statements made in this document on the focal length and specific distances with respect to the imaging element 5 then apply to the total focal lengths and the principal planes of the imaging system.

As is apparent from FIG. 5, the light is emitted from various pixels of the SLM 3, only from three different pixels of the SLM 3 in this exemplary embodiment here for reasons of clarity, where the SLM 3 modulates the light emitted by the illumination device 2 in accordance with the information of the object or scene to be reconstructed and represented. The imaging element 5 is arranged at the distance of its focal length from the SLM 3 in the display device. In this manner, the imaging element 5 can generate an image of the SLM 3 in infinity. This means that light beams which originate from the same pixel of the SLM 3 are collimated and/or extend parallel in relation to one another in the light path after the imaging element 5. However, the light beams which originate from different pixels of the SLM have different angles in relation to one another in the light direction after the imaging element 5.

Furthermore, the display device comprises the light coupling device 10, using which the light incident on the light guide 4 can be coupled into the light guide 4. This light coupling device 10 comprises at least one mirror element and/or at least one grating element and/or at least one prism element for coupling the light into the light guide 4. In FIG. 5, the light coupling device 10 comprises a mirror element for coupling the light into the light guide 4. The imaging element 5 moreover images the light source of the illumination device 2 in the illustrated YZ plane of FIG. 5 on the mirror element of the light coupling device 10 or in the general case in the vicinity of the light coupling device 10 of the light guide 4. The light beams which originate from various pixels of the SLM 3 are thus completely or at least substantially superimposed on one another on the mirror element of the light coupling device 10.

The coupled-in angular spectrum of the light, which essentially corresponds to the field of view in the Y direction, is defined by the light beams which originate from the edge pixels of the SLM 3 in the perpendicular direction, pass or pass through the imaging element 5, and are incident on the mirror element of the light coupling device 10, where the Y direction corresponds to the horizontal direction here.

As mentioned in FIGS. 4a to 4d, for example, it would also be possible that the display device of FIG. 5 comprises a projection system for imaging the SLM, where the disclosure made there is also to apply to FIG. 5.

After the incidence of the light beams on the light coupling device 10, they are coupled by means of the mirror element of the light coupling device 10 into the light guide 4. The light beams then propagate in the light guide 4 via total reflection and/or are reflected at the boundary surfaces or surfaces of the light guide 4 and coupled out of the light guide 4 by means of the arrangement of partially-reflective decoupling elements 9. The light which originates from different pixels of the SLM 3 is coupled out of the light guide 4 at different angles. This takes place in parallel to the coupling angles of the light beams in each case. The light which originates from various pixels of the SLM 3 then passes the sweet spot 7 in the light path. A sweet spot 7 is thus generated in the observer plane 8 in the non-encoding direction of the hologram, whereby a large field of view can be achieved in the non-encoding direction, the Y direction here.

The display device moreover comprises the further imaging element 11. The further imaging element 11 can comprise in this case at least one lens element, at least one imaging element having variable focal length, and/or at least one switchable imaging element. The further imaging element 11 is arranged in the light direction after the light guide 4 and/or between the light guide 4 and the observer plane 8, in which an observer can be located to observe a reconstructed three-dimensional object or scene. This further imaging element 11 is designed as a concave imaging element or concave imaging system, which comprises at least two imaging elements. The image of the SLM 3, which is located in infinity, can be displaced or moved again into a finite distance in relation to an observer using this further imaging element 11 between the coupling of the light out of the light guide 4 and the sweet spot 7 in the non-encoding direction or a virtual observer region in the encoding direction of the hologram.

The further concave imaging element 11 provided between the light guide 4 and an observer can thus be used to set the image position of the SLM 3, as is seen from the eye. If an image of the SLM 3 is generated in infinity by the optical system or the imaging element 5 in the light path before the coupling of the light into the light guide 4, the further concave imaging element 11 in the light path between the light guide 4 and the observer thus displaces the location of the SLM 3 to a finite distance in relation to the observer. For example, a further imaging element having a focal length of f=−2 m would move or displace the image of the SLM toward the observer from an infinite distance to a finite distance of 2 m in relation.

It is also shown in FIG. 5 that the display device comprises the optical component 13, which is formed here as a cylinder element. The optical component 13 is situated close to or in the vicinity of the SLM 3. This optical component 13 does not have a focusing effect in the illustrated YZ plane. However, this optical component 13 has a focusing effect in the plane perpendicular to the YZ plane. Because of its position close to or in the vicinity of the SLM 3, the optical component 13 thus has no influence on the image position of the SLM 3.

This display device according to FIG. 5 fundamentally differs from the display device 1 according to FIGS. 4a to 4d, however, in that this display device illustrated here is designed as a VR (virtual-reality) display and thus does not require a compensation element 12. However, to protect the eye of an observer of a reconstructed three-dimensional scene from undesired light, which can penetrate from the natural surroundings of the display device through the light guide 4 and can substantially impair the quality of the generated scene, this display device according to FIG. 5 comprises an absorption element 14 on the side of the light guide 4 facing away from the observer. The absorption element 14 is used in this case to shade the light incident on the light guide 4 from the natural surroundings from this side and thus prevents undesired ambient light from being incident on the eye of the observer. The absorption element 14 can preferably be arranged in this case as a single element in the vicinity of the light guide 4. As an alternative to a single absorption element 14, for example, the surface of the light guide 4 facing away from the observer can also be reflecting.

The setting of the coherence length of the light of the light source used of the illumination device will be explained with reference to FIG. 6. The light which originates or is emitted from the same pixel of the SLM and is propagated in the light guide 4 can be partially coupled out by different decoupling elements 9 and thus having different optical paths out of the light guide 4. In FIG. 6, a light beam Sin propagating in the light guide 4 is coupled out with a part of its intensity in each case by three different decoupling elements 9₁, 9₂, and 9₃, so that three light beams S1, S2, and S3 parallel to one another exit from the light guide 4, which have covered different optical paths in the light guide 4. This path difference of the individual light beams would not play a role upon the use of incoherent light here. In a holographic display device having a sufficient coherent illumination of the SLM, however, these light beams could result in undesired appearances of interference if multiple light beams thereof are incident in a pupil of an eye of an observer. A reconstructed object point of a three-dimensional scene could be amplified or attenuated undesirably in its intensity. Since an angular spectrum of the light propagates through the light guide, the path difference of the light between adjacent decoupling elements can differ, for example, for light from different pixel columns of the SLM.

However, to prevent disturbing appearances of interference from occurring, the coherence length of the light of the light source of the illumination device is to be adapted in such a way that the coherence length is less than the shortest connecting distance between two decoupling elements Δm. This shortest connecting distance Δm in turn results from the horizontal distance of the decoupling elements Δx and the angle of inclination α of the decoupling elements in relation to the surface normal N:

Δm=sin(90°−α)Δx.

Two exemplary embodiments of a display device are shown in each of FIGS. 7a to 7d, using each of which the field of view can be enlarged in the encoding direction of a hologram via tiling or segmenting. To be able to explain the principle of the display devices 100 and 200 in operation more simply, two display devices 100 and 200 are illustrated adjacent to one another in each case.

FIG. 7a illustrates a part of a display device 100, which comprises a deflection device 150 to enlarge a field of view in the encoding direction of a hologram, i.e., in the vertical and/or horizontal direction. The deflection device 150 comprises two deflection elements 151 and 152 in this exemplary embodiment, where the deflection device can also comprise further or multiple deflection elements. At least one of the deflection elements is designed as switchable. The two imaging elements 151 and 152 are arranged offset in relation to one another in the light direction before the light guide 140. In this exemplary embodiment, the deflection elements 151 and 152 are designed as grating elements. Between an SLM 103 and the coupling of the light emitted by a light source 102 of an illumination device into a light guide 140 via a light coupling device (not shown here), two deflection elements in the form of grating elements 151 and 152 are thus provided, of which the grating element 152 is designed as switchable and/or controllable. In general, the deflection angles of the grating elements can also vary with the position on the grating element, so that the grating elements can comprise focusing components, for example. A combination of deflection grating and diffractive lens is thus provided.

The principle of the enlargement of the field of view by means of tiling or segmenting takes place as follows, for example: The light emitted by the light source 102 is incident via an illumination optical unit 106 on the SLM 103, is modulated thereby in accordance with the information of an object or scene to be reconstructed, passes an optical component 130 and an imaging element 105, and is then incident on the grating element 151 of the deflection device 150 in the light path. This grating element 151 is embodied as switchable. If the grating element 151 is in a switched-off state, as shown in the left part of FIG. 7a, the light modulated by the SLM 103 passes the grating element 151 undeflected, as illustrated by the arrows, so that it is incident without deflection on the light guide 140. The undeflected light is then incident on the light coupling device and is coupled at a first position into the light guide 140. However, if the grating element 151 is in a switched-on state, as shown in the right part of FIG. 7a, the light modulated by the SLM 103 is thus deflected accordingly by this grating element 151. The deflected light propagates in the direction of the grating element 152 and is incident thereon. This grating element 152 is not a switchable deflection element. The light incident on the grating element 152 is also deflected thereby, so that the light is then incident on the surface of the light guide 140 and is coupled by means of the light coupling device into the light guide 140. Due to the deflecting effect of both grating elements 151 and 152, the light is coupled into the light guide 140 offset in relation to a coupling position of previously coupled-in light. This means that the coupling position of the light on the light guide 140 can be selected and established by means of the deflection device 150. In this manner, by means of the light guide 140 and the deflection device 150, an image of the SLM 103 or image of an order of diffraction in a Fourier plane of the SLM 103 composed of segments or tiles can be generated. This segmented image of the SLM 103 defines a field of view, within which an item of information of a scene which is encoded in the SLM 103 can be reconstructed for observation through a virtual observer region in the plane of a light source image or in an image plane of the SLM 103. This means the SLM 103 is imaged multiple times by means of the imaging elements. The individual images of the SLM 103 represent segments or tiles which are juxtaposed vertically and/or horizontally by means of the deflection device 150 to generate a large field of view. Various contents for the respective segments are written time-sequentially in the SLM 103 for this purpose.

By adding further grating elements, as shown in FIG. 7c, in the deflection device, more than two segments or tiles of an image or an order of diffraction of the SLM can be generated. An even larger field of view can thus be generated by a plurality of deflection elements. In preferred embodiments, the number of the segments is between 2 and 4, for example, for a vertical encoding direction of a hologram in an SLM. In further embodiments, for example, for a horizontal encoding direction of a hologram in an SLM, however, the number of the segments can also be greater than 4, for example, between 2 and 10 segments.

FIG. 7b schematically shows a display device 200, where only the part of the display device 200 from a light source 202 of an illumination device to a light guide 240 is also shown here, as in FIG. 7a. This display device 200 comprises the same components as the display device 100 according to FIG. 7a, where here, however, a deflection device 250 is provided, which comprises mirror elements 256 and 257 as deflection elements instead of grating elements as in FIG. 7a. A first mirror element 256 is formed here in the form of a wire grid polarizer (WGP). This mirror element 256 is combined with a polarization switch 255, to embody it as switchable. At least one mirror element of the deflection device 250 is thus designed as switchable. The mirror element 256 has a transmissive effect for a polarization direction of the light emitted by the light source 202, but the mirror element 256 has a reflective effect for a polarization direction of the light perpendicular thereto. The polarization switch 255 can be designed, for example, as a liquid-crystal-based element.

The principle of the enlargement of the field of view by means of tiling or segmenting via mirror elements in the deflection device 200 takes place as follows, for example: The light emitted by the light source 202 is incident via an illumination optical unit 206 on the SLM 203, is modulated thereby in accordance with the information of an object or scene to be reconstructed, passes an optical component 213 and an imaging element 205, and is then incident on the deflection device 250 in the light path. The case is shown in the left part of FIG. 7b in which the polarization of the light incident on the deflection device 250 is switched in such a way that the mirror element 256 transmits the light which is emitted by the SLM 203, so that it is incident without deflection on the light guide 240. The undeflected light is then incident on the light coupling device (not shown here) and is coupled at a first position into the light guide 240.

In the right part of FIG. 7b, however, the polarization of the light incident on the light deflection device 250 is switched in such a way that the mirror element 256 reflects the light which is emitted by the SLM 203. The light thus reflected is incident on the mirror element 257. The mirror element 257 can then be deflected in such a way that it is coupled into the light guide 240 at a different position than the undeflected light. This also means here that the coupling position of the light on the light guide 240 can be selected and established by means of the deflection device 250. In this manner, an image of the SLM 203 or alternatively an image of an order of diffraction in a Fourier plane of the SLM 203 composed of segments or tiles can be generated by means of the light guide 240 and the deflection device 250. This segmented image of the SLM 203 defines a field of view, within which an item of information of a scene encoded in the SLM 203 can be reconstructed for observation through a virtual observer region in the plane of a light source image or in an image plane of the SLM 203. This means the SLM 203 is imaged multiple times by means of the imaging elements, where different contents are written in the SLM 203 in each case, however. The individual images of the SLM 203 represent segments or tiles which are juxtaposed vertically and/or horizontally by means of the deflection device 250 to generate a large field of view.

In the general case, the mirror elements 256 and 257 do not have to be embodied as flat or planar, but rather can also comprise a curvature and/or contain focusing functions, for example. The deflection device is also expandable to the generation of more than two segments or tiles by an arrangement having additional polarization switches and additional mirror elements 256, as shown in FIG. 7d. An even larger field of view can thus be generated by a plurality of deflection elements.

The display device 100 according to FIG. 7a is illustrated in FIG. 7c, where the display device 100 is now designed for the case of generating an image of the SLM 103 composed of three segments or tiles using the deflection device 150. The switchable grating element 151 comprises at least three switching states in this exemplary embodiment. In an off state according to the middle image of FIG. 7c, the grating element 151 transmits the light which is modulated by the SLM 103 and is now incident in a through and undeflected manner. In a first on state of the grating element 151 according to the left image in FIG. 7c, this grating element 151 deflects the light to the left or in the direction of a grating element 153. In a second on state of the grating element 151 according to the right image in FIG. 7c, this grating element 151 deflects the light to the right or in the direction of the grating element 152.

The two grating elements 152 and 153 are designed as passive grating elements and are arranged in the display device 100 in such a way that the light deflected to the left by the grating element 151 is incident on the grating element 153 and the light deflected to the right by the grating element 151 is incident on the grating element 152, respectively.

The following is respectively shown in the left, middle, and right images of FIG. 7c: In the left image, the generation of a left segment of an image of the SLM 103 with the aid of the grating elements 151 and 153 is illustrated. In the middle image, the generation of a middle segment is illustrated, where the grating element 151 is in a switched-off state here and the light is incident undeflected on the light guide 140. In the right image, the generation of a right segment with the aid of the grating elements 151 and 152 is illustrated. The generation of the individual segments is performed according to the procedure described with respect to FIG. 7a.

Only a single switchable grating element is advantageously required here, which does have to have at least three switching states, however. If, for example, the grating element 151 is a grating element having a variably writable grating period, additional further deflection angles and therefore further segments can thus be implemented. If, for example, the grating element 151 is a controllable polarization grating, a deflection alternately to the left or right can thus be implemented by changing the rotational direction of the grating element at equal period.

The display device 200 according to FIG. 7b is illustrated in FIG. 7d, where the display device 200 is now designed for the case of generating an image of the SLM 203 composed of three segments or tiles using the deflection device 250.

In this exemplary embodiment, two redirection elements are provided for generating the three segments, which comprise mirror segments 256 and 258 in the form of wire grid polarizers, which are combined with two polarization switches 255 and 259.

The generation of the three segments of the image of the SLM 203 takes place as follows in this case: As can be seen in the left image of FIG. 7d, the polarization switch 255 is in a switched-off state for generating a first segment according to FIG. 7b, so that the incident light can pass undeflected through the mirror element 256 and can be incident on the light guide 240. The incident linearly polarized light modulated by the SLM 203 thus passes the polarization switch 255 and the mirror element 256 and is incident on the light guide 240.

The middle image of FIG. 7d illustrates how a second segment can be generated. To generate the second segment, the polarization switch 255 is moved into a switched-on state. The polarization of the light emitted by the SLM 203 is then rotated by means of the polarization switch 255 in such a way that the light is reflected by the mirror element 256 and directed in the direction of the mirror element 258. The further polarization switch 259 is located in a switched-off state. The polarization of the light then remains unchanged between the mirror element 256 and the mirror element 258, so that the light is also reflected at the mirror element 258 and then guided in the direction of the light guide 240 and coupled into this light guide 240.

A third segment of the image of the SLM 203 is now generated according to the right image in FIG. 7d. In this case, both polarization switches 255 and 259 are in a switched-on state. The light modulated by the SLM 203 is now reflected by the mirror element 256. Since the polarization of the light is rotated only once between the two mirror segments 256 and 258 by means of the polarization switch 259, however, the light passes the mirror element 258 undeflected. This light is then incident on the mirror element 257 and is reflected thereon in the direction of the light guide 240 and coupled into the light guide 240.

In this manner, the coupling location or the coupling position of the light into the light guide 204 is changed accordingly, so that three segments of the image of the SLM 203 can be generated. It is obviously possible that these display devices 100 and 200 can also be expanded by further grating elements or further redirection elements, which comprise mirror elements in conjunction with polarization switches, to generate additional segments or tiles. However, the number of the required switchable elements also increases with the number of the segments.

One embodiment of a display device, which uses a more complex optical system made of multiple imaging elements between an SLM and a coupling of light into a light guide, and which can also provide tiling or segmenting to enlarge the field of view in the encoding direction and also preferably provides a single parallax encoding, is illustrated in FIGS. 8a to 8c. The optical structure of the display device 300 of FIGS. 8a to 8c fundamentally corresponds to the optical structure of the display device 1 according to FIGS. 4a to 4d. A single parallax encoding of a hologram on the SLM is also again to be assumed here.

In comparison to the exemplary embodiment of the display device 1 according to FIGS. 4a to 4d, which comprises an imaging element 5 in the form of a single spherical imaging element, for example, a lens, and an optical component 13 in the form of a single cylindrical imaging element, for example, a cylinder lens, however, a plurality of imaging elements is provided between an SLM 330 and a light guide 340 in illustrated FIGS. 8a to 8c. In this exemplary embodiment, a total of ten imaging elements in the form of lenses are provided in the display device 300, where mirror elements or grating elements can also be provided instead of lenses and the number of imaging elements can also vary. An imaging element 305, which comprises multiple elements here, and an imaging system 360, which also comprises multiple elements, are formed at least partially spherical, where an optical component 313 is formed cylindrical. An element 314 of the imaging system 360 is not formed cylindrical, but also has, for example, different radii of curvature and thus also different focal lengths in the horizontal and vertical directions. This is to illustrate by way of example that the present invention is not to be restricted to the use of a few, such as two or three, imaging elements. The function of a spherical imaging element, such as the imaging element 305, and a cylindrical optical component, such as the optical component 313, can also be exchanged and/or nested with respect to the sequence of the arrangement thereof in the display device 300. The sequence of the imaging elements, spherical or approximately cylindrical, and of a possibly provided deflection device 350, which comprises at least one switchable grating element or mirror element or redirection element, for generating individual segments or tiles of the SLM 330 can be exchanged or nested.

The illustrated optical system made of the imaging system 360, the imaging element 305, and the optical component 313 has the effect that a one-dimensional light source image of at least one light source of an illumination device (not shown) can be generated at the position of an observer region 307 in the light path in the encoding direction after coupling of the light out of the light guide 340, and a one-dimensional light source image of the light source of the illumination device can be generated at the or in the vicinity of the coupling position of the light into the light guide 340 in the light path in the non-encoding direction.

In the illustrated optical system, an intermediate image of the SLM 330 is generated using the imaging system 360. The optical component 313 is arranged in this case in the image plane of the SLM. An intermediate image of the SLM 330 thus results in the region of the optical component, so that the optical component also does not have an influence on the further image position of the spatial light modulator device in this exemplary embodiment.

The deflection device 350 is provided between the first pair of spherical imaging elements of the imaging system 360, which follow immediately after the SLM 330 in the beam path. The deflection device 350 comprises a switchable grating element.

The respective light paths for generating in each case one segment of an image of the SLM 330 are schematically illustrated in FIGS. 8b and 8c for a first switching state of the grating element (FIG. 8b) and a second switching state of the grating element (FIG. 8c) of the deflection device 350. Depending on the switching state of the grating element of the deflection device 350, the light modulated by the SLM 330 is incident on the following elements of the imaging system 360, the optical component and the imaging element 305, at different positions and generates two different segments or tiles in the encoding direction. The segments are each one image of the SLM 330 and are generated so that a large field of view can be achieved. This means the segments are juxtaposed vertically and/or horizontally overlapping or without a gap to generate a large field of view. These segments as images of the SLM result in the plane, in which the optical component 313 is also located, vertically offset in relation to one another here. FIG. 8b thus shows the first segment and FIG. 8c shows the second segment.

In contrast to the specific embodiments of a display device having tiling or segmenting comprising in each case two or more grating elements or mirror elements shown in FIGS. 7a to 7d, in the specific embodiment shown here according to FIGS. 8a to 8c, only a single switchable grating element is used in the deflection device 350. Instead of a second grating element, the size of the imaging elements following in the light direction is designed in such a way that the light propagating from the grating element, depending on the switching state of the grating element, passes essentially either the upper region of the following imaging elements, as shown in FIG. 8b, or passes essentially the lower region of the following imaging elements, as shown in FIG. 8c. The single switchable grating element of the deflection device 350 in combination with the imaging elements and optical components provided in the beam path is thus provided for generating individual segments in a suitable manner.

The options for the tiling or segmenting of the vertical and/or horizontal field of view are not to be restricted to the illustrated and described exemplary embodiments.

It is to be illustrated on the basis of FIG. 9 how the distance of the partially-reflective decoupling elements S in the light guide 4 is to be selected. As can be seen, the partially-reflective decoupling elements S1, S2, and S3 are each arranged at an angle α in relation to the normal N in the light guide 4. If a projection of the partially-reflective decoupling elements S1, S2, and S3 on the surface of the light guide 4 is regarded, where the projection was only performed for the decoupling elements S1 and S2 here, this projection is preferably not to comprise gaps for adjacent decoupling elements S1, S2, S3, . . . .

The case is shown in image (a) of FIG. 9 in which the partially-reflective decoupling elements S1, S2, and S3 are arranged at an excessively large distance in relation to one another. As is apparent, a gap is formed between a projection P1 of the decoupling element S1 and a projection P2 of the decoupling element S2 by such an arrangement of the decoupling elements S1, S2, and S3 in the light guide. Gaps can thus be present in the generated sweet spot in the non-encoding direction of a hologram in the case of a single parallax encoding. If a hologram is encoded by means of a full parallax encoding in the SLM, gaps can then also be present in the virtual observer region. These gaps would substantially disturb the perception of a three-dimensional scene by an observer.

The projections of the partially-reflective decoupling elements S1, S2, and S3 on the surface or boundary surface of the light guide 4 are preferably also not to have large overlaps. The projections are either to adjoin one another without overlap or are only to have a very small overlap, for example, of at most 10%.

Such a case is illustrated in image (b) of FIG. 9, in which a small overlap of the projections P1 and P2 of the decoupling elements S1 and S2 is present on the surface or boundary surface of the light guide 4. Such an arrangement of the partially-reflective decoupling elements in the light guide 4 is preferred, since in this way no gaps result in the sweet spot and/or virtual observer region.

A thin and lightweight light guide is preferably to be used in the display device. To limit the expenditure in manufacturing of the light guide, moreover as few as possible partially-reflective decoupling elements are to be provided in the light guide.

To generate a large field of view using few partially-reflective decoupling elements in a thin light guide, the decoupling elements are preferably to be inclined and arranged at a large angle α in relation to the normal N.

A specific embodiment of a thin light guide 4 is illustrated in FIG. 10, which can be used in the display devices illustrated in the drawing. In this light guide 4, the partially-reflective decoupling elements S1 and S2 are arranged at an angle of inclination α of 72.5° in relation to the normal N. The light guide 4 has a thickness here of d=1.6 mm. In this exemplary embodiment, the distance of the decoupling elements in relation to one another is then x=d tan α=5.1 mm. Only two decoupling elements are illustrated in FIG. 10. With such an arrangement of the decoupling elements in the light guide, for example, a field of view of approximately 35° can be implemented using six decoupling elements.

The boundary surfaces of the light guide 4 can be provided with a reflective layer to enhance the reflectivity of these boundary surfaces for the incident light. This is reasonable in particular if total reflection would not occur at the boundary surfaces during the propagation of the light in the light guide.

The coupling of light, which is to be illustrated here by the dashed arrow, into the light guide 4 does not take place in FIG. 10 via a mirror element as a light coupling device, but rather via a prism element 20. The prism angle γ of the prism element 20 is 35° here. It is thus ensured that light which is coupled in perpendicularly in relation to the surface of the prism element 20 is also coupled out perpendicularly in relation to the surface of the light guide 4. This therefore has the result that the angle of the decoupling elements corresponds to 17.5° to the horizontal and the prism angle γ corresponds to twice this angle, i.e., 2×17.5°=35°.

The partially-reflective decoupling elements S1 and S2 are adapted or formed in this exemplary embodiment in such a way that they partially reflect light incident at small angles in relation to the normal N on the surface of the decoupling elements S1 and S2 and transmit light incident at large angles in relation to the normal N on the surface of the decoupling elements S1 and S2.

The illumination angle of the SLM (not shown here) or a scattering element can be adapted or set in this case in such a way that the surface of one side of the prism element 20, through which the light passes, is completely illuminated in the non-encoding direction.

Of course, the invention is not to be restricted to the numeric examples mentioned in this exemplary embodiment according to FIG. 10. The angles of inclination α of the partially-reflective decoupling elements in the light guide can preferably be between 55° and 75° in relation to the normal N. The angle of inclination range can also be selected as larger, however. FIG. 11 roughly schematically shows one option for producing a light guide having partially-reflective decoupling elements.

The material of the light guide, preferably an optical plastic or glass, is firstly divided into individual sections A according to image (a). The angle of the cut surfaces of the individual sections A preferably corresponds in this case to the desired angle of inclination α of the decoupling element to be produced in this manner.

According to Figure (b), partially-reflective layers TS, for example, in the form of a dielectric layer stack, i.e., a coating, are then applied to the cut surfaces of the individual sections A in such a way that a partially-reflective layer TS is provided between each two sections A. If a dielectric layer stack is provided as a partially-reflective layer TS, the index of refraction, the order, and the thickness of the individual layers of the dielectric layer stack are then to be adapted in such a way that a partial reflection of the incident light occurs in a specific range of light angles of incidence. Subsequently, according to image (c) of FIG. 11, the individual sections A having the partially-reflective layers TS are joined together again to form a light guide, for example, via adhesive bonding. In this manner, exemplary decoupling elements can be produced in the light guide.

This method of producing a light guide is solely an exemplary embodiment. A light guide in which the display device can be used can also be produced in another manner, of course. The invention is therefore not to be restricted to the use of a light guide produced in this manner.

For example, in one simple embodiment of a light guide, all partially-reflective decoupling elements have the same reflectivity. However, a gradient of the brightness would result therefrom. Since a part of the light is already coupled out at the first decoupling elements of the light guide on which the light propagating in the light guide is first incident, only a smaller proportion of the total light entering the light guide is still incident on the following decoupling elements. If the same percentage of the incident light is always coupled out via the decoupling elements, the absolute intensity of the decoupled light decreases with each additional decoupling element in the light guide.

This could be compensated for, for example, by the illumination of the SLM or by the writing of content in the SLM. For this purpose, for example, a lower amplitude of the subholograms could be associated with the left part of the scene to be represented than the right part of the scene to be represented.

Alternatively, for example, the light guide could comprise decoupling elements which individually have different reflectivities. In this manner it could be achieved that, a relatively large proportion of the light incident in the light guide could still be coupled out at the decoupling elements provided last in the light path or at the decoupling elements which are situated after the first decoupling elements in the light path. The absolute decoupled intensity of the light can then be nearly equal for all decoupling elements in the light guide.

If the decoupling elements are each formed as a dielectric layer stack, for example, the layer stack can be individually adapted for each decoupling element to achieve the desired reflectivity.

Moreover, combinations of the embodiments and/or exemplary embodiments are possible. Finally, it is very particularly to be noted that the above-described exemplary embodiments are used solely to describe the claimed teaching, but do not restrict this teaching to the exemplary embodiments.

1. A display device, in particular a near-to-eye display device, comprising
at least one illumination device for emitting sufficiently coherent light,
at least one spatial light modulator device,
at least one imaging element for imaging light originating from the at least one light modulator device,
at least one light guide, and
at least two partially-reflective decoupling elements, which are provided in the at least one light guide, for coupling the light out of the light guide.

2. The display device as claimed in claim 1, wherein the partially-reflective decoupling elements are designed as mirror elements or prism elements.

3. The display device as claimed in claim 1, wherein the partially-reflective decoupling elements are parallel to one another.

4. The display device as claimed in claim 1, wherein the partially-reflective decoupling elements are arranged at a predefined distance in relation to one another.

5. The display device as claimed claim 1, wherein the partially-reflective decoupling elements are arranged in such a way that these decoupling elements deflect the light propagating in the at least one light guide in a predefined direction.

6. The display device as claimed in claim 1, wherein a light coupling device is provided, using which the light incident on the at least one light guide can be coupled into the light guide.

7. The display device as claimed in claim 6, wherein the light coupling device comprises at least one mirror element and/or at least one grating element and/or at least one prism element.

8. The display device as claimed in claim 1, wherein a one-dimensional hologram is preferably encoded in the at least one spatial light modulator device.

9. The display device as claimed in claim 1, wherein the at least one imaging element comprises at least one lens element and/or one mirror element and/or one grating element.

10. The display device as claimed in claim 1, wherein the at least one imaging element is arranged in the light direction before the at least one light guide, in particular between the at least one spatial light modulator device and the at least one light guide.

11. The display device as claimed in claim 1, wherein the at least one imaging element is provided for imaging of the at least one spatial light modulator device into infinity.

12. The display device as claimed in claim 1, wherein at least one further imaging element is provided, which is arranged in the light direction after the at least one light guide.

13. The display device as claimed in claim 12, wherein the at least one further imaging element is provided for imaging of an intermediate image of the at least one spatial light modulator device, which is generatable by the at least one imaging element in infinity, at a finite distance.

14. The display device as claimed in claim 12, wherein the at least one further imaging element comprises at least one lens element and/or at least one imaging element having variable focal length and/or at least one switchable imaging element.

15. The display device as claimed in claim 1, wherein at least one compensation element is provided.

16. The display device as claimed in claim 15, wherein the compensation element is arranged on the side of the at least one light guide opposite to the at least one further imaging element.

17. The display device as claimed in claim 15, wherein the compensation element comprises at least one lens element and/or at least one imaging element having variable focal length and/or at least one switchable imaging element.

18. The display device as claimed in claim 1, wherein the coherence length of the light is set in such a way that the coherence length is less than the shortest distance of two partially-reflective decoupling elements in the at least one light guide.

19. The display device as claimed in claim 1, wherein at least one optical component is provided, which in particular comprises a cylinder element.

20. The display device as claimed in claim 19, wherein the at least one optical component is arranged in the light path immediately after the at least one spatial light modulator device or in an image plane of the at least one spatial light modulator device.

21. The display device as claimed in claim 1, wherein a virtual observer region is generatable in a Fourier plane or in an image plane of the at least one spatial light modulator device in at least one encoding direction of a hologram and in light direction after the at least one light guide.

22. The display device as claimed in claim 21, wherein if a single parallax encoding of a hologram is provided in the at least one spatial light modulator device, a sweet spot is generatable in a non-encoding direction of the hologram.

23. The display device as claimed in claim 1, wherein a light source image of at least one light source of the at least one illumination device is generatable in the light path after a coupling of the light out of the at least one light guide at the position of a virtual observer region in the encoding direction.

24. The display device as claimed in claim 1, wherein if a single parallax encoding of a hologram is provided in the at least one spatial light modulator device, a light source image of at least one light source of the at least one illumination device is generatable at or close to a coupling position of the light into the light guide in a non-encoding direction in the light path.

25. The display device as claimed in claim 19, wherein the at least one optical component is provided for generating a horizontal light source image and a vertical light source image, where the light source images result at different positions in the beam path.

26. The display device as claimed in claim 23, wherein a virtual observer region is generatable in at least one encoding direction in a plane of a light source image provided in the light direction after the at least one light guide or in a plane of an image of the spatial light modulator device provided in the light direction after the at least one light guide.

27. The display device as claimed in claim 1, wherein a deflection device is provided for enlarging a field of view in a horizontal and/or vertical direction.

28. The display device as claimed in claim 27, wherein the deflection device comprises at least two deflection elements, of which at least one deflection element is designed as switchable, where the deflection elements are preferably designed as grating elements or mirror elements or redirection elements.

29. The display device as claimed in claim 28, wherein one of the at least two deflection elements is designed as a redirection element, which comprises at least one mirror element, preferably a wire grid polarizer, and at least one polarization switch, and another of the at least two deflection elements is designed as a mirror element.

30. The display device as claimed in claim 28, wherein the at least two deflection elements are arranged offset in relation to one another in the light direction before the at least one light guide.

31. The display device as claimed in claim 27, wherein an image of the at least one spatial light modulator device composed of segments is generatable by means of the at least one light guide and the deflection device, where the image defines a field of view within which an item of encoded information of a scene in the spatial light modulator device is reconstructable for observation through the virtual observer region in the plane of a light source image.

32. The display device as claimed in claim 1, wherein the light propagates within the at least one light guide via a reflection on boundary surfaces of the light guide, and where the coupling of light bundles of the light out of the light guide is provided in each case at predefined partially-reflective decoupling elements.

33. The display device as claimed in claim 1, wherein the spatial light modulator device is designed as a phase-modulating spatial light modulator device or as a complex-valued spatial light modulator device.

34. The display device as claimed in claim 1, wherein the display device is designed as a head-mounted display or as an augmented-reality display or as a virtual-reality display.

35. A method for representing a reconstructed scene, carried out using a display device as claimed in claim 1.
